(19) United States
(12) Patent Application Publication
(10) Pub. No.: US 2017/0364931 A1
(43) Pub. Date: Dec. 21, 2017

(54) DISTRIBUTED MODEL OPTIMIZER FOR CONTENT CONSUMPTION

(71) Applicant: Bombora, Inc., New York, NY (US)

(72) Inventors: Oleg Valentin Khavronin, Oakland, NJ (US); Benny Lin, Brooklyn, NY (US); Anthony Livhits, Forest Hill, NY (US); Erik Gregory Matlick, Miami Beach, FL (US); Christian Michael Burton, New York, NY (US); Robert James Armstrong, Reno, NV (US)

(21) Appl. No.: 15/690,127

(22) Filed: Aug. 29, 2017

Related U.S. Application Data
(63) Continuation-in-part of application No. 14/981,529, filed on Dec. 28, 2015.
Application No. 14/981,529 is a continuation-in-part of application No. 14/498,056, filed on Sep. 26, 2014.

(51) Int. Cl. G06Q 30/02; G06F 17/30

(52) U.S. Cl. CPC G06Q 30/0201; G06F 17/30687; G06F 17/30705

(57) ABSTRACT

A distributed model generation system includes a master node that estimates parameter sets for a topic classification (TC) model. The estimated parameter sets are loaded into a queue. Multiple training nodes download the estimated parameter sets from the queue for training associated TC models. The training nodes generate model performance values for the trained TC models and send the model performance values back to the master node. The master node uses the model performance values and the associated parameter sets to estimate additional TC model parameter sets. The master node estimates new parameter sets until a desired model performance value is obtained. The master node may use a Bayesian optimization to more efficiently estimate the parameter sets and may distribute the high processing demands of model training and testing operations to the training nodes.

The present application is a continuation in part of U.S. patent application Ser. No. 14/981,529, entitled: SURGE DETECTOR FOR CONTENT CONSUMPTION, which is a continuation in part of U.S. patent application Ser. No. 14/498,056, entitled: CONTENT CONSUMPTION MONITOR, which are both herein incorporated by reference in their entireties.

### BACKGROUND

A topic model is a type of statistical model used for discovering topics that occur in a collection of content, such as documents. The topic model is trained on a set of training data and then tested on a set of test data to determine how well the topic model classifies data into different topics. The training and testing process is often iterative where different parameter sets are selected for training the model. The model is then tested to determine a performance level for the selected parameter set. Based on the results, another parameter set is selected to retrain and retest the model to hopefully improve model topic classification performance. Different parameter sets are tested until the model reaches a desired performance level.

The iterative process of training and testing topic models is computationally intensive and may take hours to train the model with each selected parameter set. The number or variety of topics, or the quality of topic models, used in a natural language analysis system may be restricted due to the heavy time and computer demands associated with training new topic models.

### BRIEF DESCRIPTION OF THE DRAWINGS

FIG. 1 depicts an example content consumption monitor (CCM).

FIG. 2 depicts an example of the CCM in more detail.

FIG. 3 depicts an example operation of a CCM tag.

FIG. 4 depicts example events processed by the CCM.

FIG. 5 depicts an example user intent vector.

FIG. 6 depicts an example process for segmenting users.

FIG. 7 depicts an example process for generating company intent vectors.

FIG. 8 depicts an example consumption score generator.

FIG. 9 depicts the example consumption score generator in more detail.

FIG. 10 depicts an example process for identifying a surge in consumption scores.

FIG. 11 depicts an example process for calculating initial consumption scores.

FIG. 12 depicts an example process for adjusting the initial consumption scores based on historic baseline events.

FIG. 13 depicts an example process for mapping surge topics with contacts.

FIG. 14 depicts an example content consumption monitor calculating content intent.

FIG. 15 depicts an example process for adjusting a consumption score based on content intent.

FIG. 16 depicts an example model optimizer used in the CCM.

FIG. 17 depicts an example of the model optimizer in FIG. 16 in more detail.

FIG. 18 depicts an example of how the model optimizer generates parameter sets.

FIG. 19 depicts an example process used by a main node in the model optimizer.

FIG. 20 depicts an example process used by training nodes in the model optimizer.

FIG. 21 depicts an example computing device for the CCM.

### DETAILED DESCRIPTION

A distributed model generation system includes a master node that estimates parameter sets for a topic classification (TC) model. The estimated parameter sets are loaded into a queue. Multiple training nodes download the estimated parameter sets from the queue for training associated TC models. The training nodes generate model performance values for the trained TC models and send the model performance values back to the master node. The master node uses the model performance values and the associated parameter sets to estimate additional TC model parameter sets. The master node estimates new parameter sets until a desired model performance value is obtained. The master node may use a Bayesian optimization to more efficiently estimate the parameter sets and may distribute the high processing demands of model training and testing operations to the training nodes.

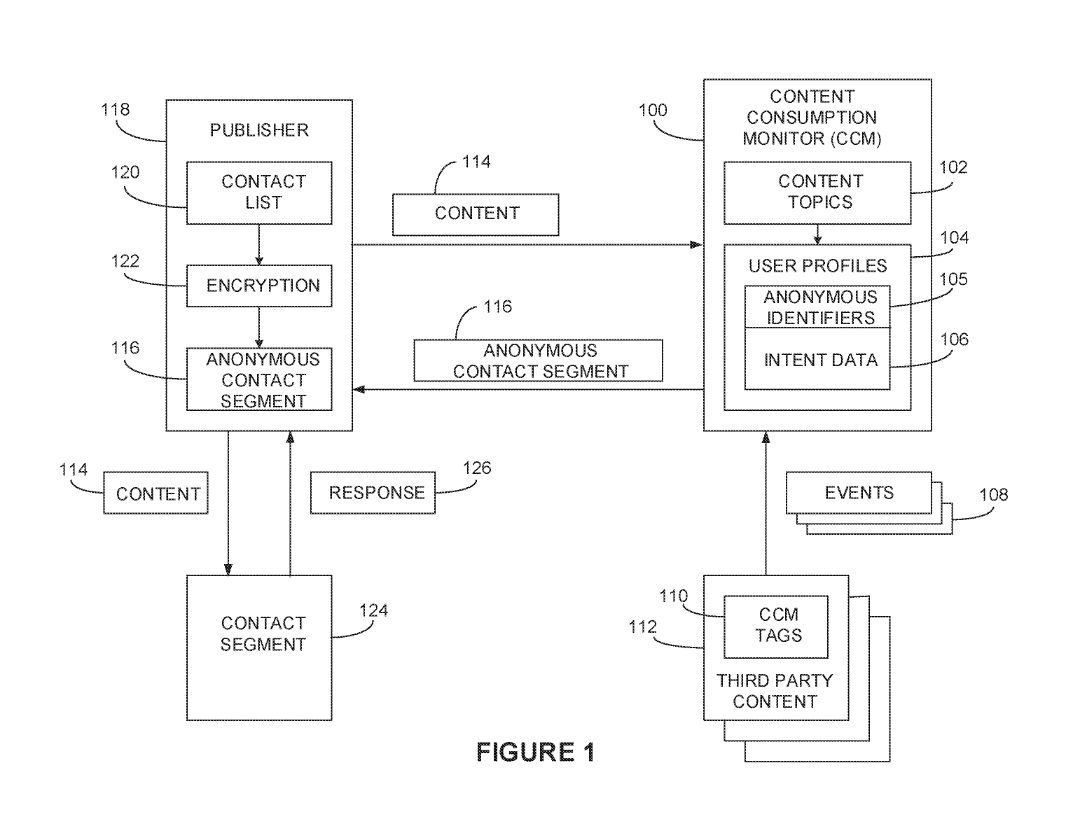

FIG. 1 depicts a content consumption monitor (CCM) 100. CCM 100 may be a server or any other computing system that communicates with a publisher 118 and monitors user accesses to third party content 112. Publisher 118 is any server or computer operated by a company or individual that wants to send content 114 to an interested group of users. This group of users is alternatively referred to as contact segment 124.

For example, publisher 118 may be a company that sells electric cars. Publisher 118 may have a contact list 120 of email addresses for customers that have attended prior seminars or have registered on the publisher website. Contact list 120 also may be generated by CCM tags 110 that are described in more detail below. Publisher 118 also may generate contact list 120 from lead lists provided by third parties lead services, retail outlets, and/or other promotions or points of sale, or the like or any combination thereof. Publisher 118 may want to send email announcements for an upcoming electric car seminar. Publisher 118 would like to increase the number of attendees at the seminar.

Third party content 112 comprises any information on any subject accessed by any user. Third party content 112 may include web pages provided on website servers operated by different businesses and/or individuals. For example, third party content 112 may come from different websites operated by on-line retailers and wholesalers, on-line newspapers, universities, blogs, municipalities, social media sites, or any other entity that supplies content.

Third party content 112 also may include information not accessed directly from websites. For example, users may access registration information at seminars, retail stores, and other events. Third party content 112 also may include content provided by publisher 118.

Computers and/or servers associated with publisher 118, content segment 124, CCM 100 and third party content 112 may communicate over the Internet or any other wired or wireless network including local area networks (LANs), wide area networks (WANs), wireless networks, cellular networks, Wi-Fi networks, Bluetooth® networks, cable networks, or the like, or any combination thereof.

Some of third party content 112 may contain CCM tags 110 that capture and send events 108 to CCM 100. For example, CCM tags 110 may comprise JavaScript added to website web pages. The website downloads the web pages, along with CCM tags 110, to user computers. User computers may include any communication and/or processing device including but not limited to laptop computers, personal computers, smart phones, terminals, tablet computers, or the like, or any combination thereof. CCM tags 110 monitor web sessions send some captured web session events 108 to CCM 100.

Events 108 may identify third party content 112 and identify the user accessing third party content 112. For example, event 108 may include a universal resource locator (URL) link to third party content 112 and may include a hashed user email address or cookie identifier associated with the user that accessed third party content 112. Events 108 also may identify an access activity associated with third party content 112. For example, event 108 may indicate the user viewed a web page, downloaded an electronic document, or registered for a seminar.

CCM 100 builds user profiles 104 from events 108. User profiles 104 may include anonymous identifiers 105 that associate third party content 112 with particular users. User profiles 104 also may include intent data 106 that identifies topics in third party content 112 accessed by the users. For example, intent data 106 may comprise a user intent vector that identifies the topics and identifies levels of user interest in the topics.

As mentioned above, publisher 118 may want to send an email announcing an electric car seminar to a particular contact segment 124 of users interested in electric cars. Publisher 118 may send the email as content 114 to CCM 100. CCM 100 identifies topics 102 in content 114.

CCM 100 compares content topics 102 with intent data 106. CCM 100 identifies the user profiles 104 that indicate an interest in content 114. CCM 100 sends anonymous identifiers 105 for the identified user profiles 104 to publisher 118 as anonymous contact segment 116.

Contact list 120 may include user identifiers, such as email addresses, names, phone numbers, or the like, or any combination thereof. The identifiers in contact list 120 are hashed or otherwise de-identified by an algorithm 122. Publisher 118 compares the hashed identifiers from contact list 120 with the anonymous identifiers 105 in anonymous contact segment 116.

Any matching identifiers are identified as contact segment 124. Publisher 118 identifies the unencrypted email addresses in contact list 120 associated with contact segment 124. Publisher 118 sends content 114 to the email addresses identified for contact segment 124. For example, publisher 118 sends email announcing the electric car seminar to contact segment 124.

Sending content 114 to contact segment 124 may generate a substantial lift in the number of positive responses 126. For example, assume publisher 118 wants to send emails announcing early bird specials for the upcoming seminar. The seminar may include ten different tracks, such as electric cars, environmental issues, renewable energy, etc. In the past, publisher 118 may have sent ten different emails for each separate track to everyone in contact list 120.

Publisher 118 may now only send the email regarding the electric car track to contacts identified in contact segment 124. The number of positive responses 126 registering for the electric car track of the seminar may substantially increase since content 114 is now directed to users interested in electric cars.

In another example, CCM 100 may provide local ad campaign or email segmentation. For example, CCM 100 may provide a “yes” or “no” as to whether a particular advertisement should be shown to a particular user. In this example, CCM 100 may use the hashed data without re-identification of users and the “yes/no” action recommendation may key off of a de-identified hash value.

CCM 100 may revitalize cold contacts in publisher contact list 120. CCM 100 can identify the users in contact list 120 that are currently accessing other third party content 112 and identify the topics associated with third party content 112. By monitoring accesses to third party content 112, CCM 100 may identify current user interests even though those interests may not align with the content currently provided by publisher 118. Publisher 118 might reengage the cold contacts by providing content 114 more aligned with the most relevant topics identified in third party content 112.

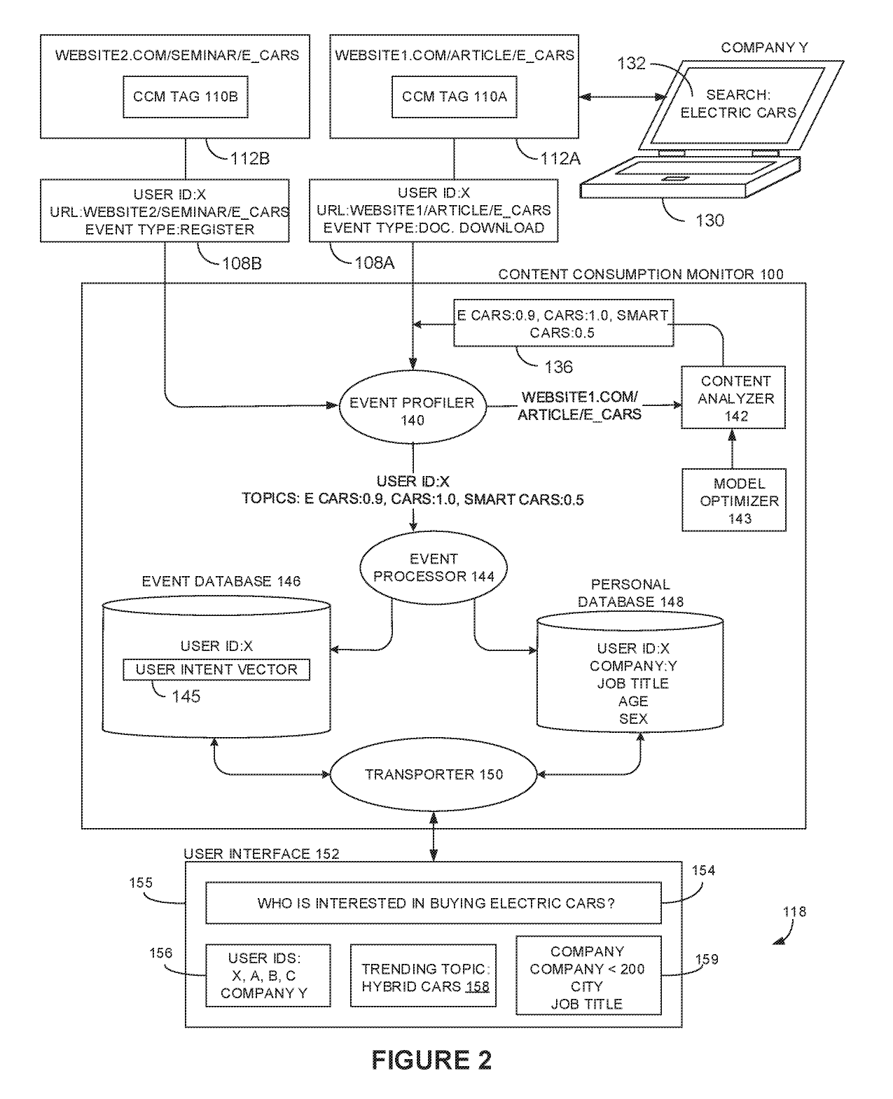

FIG. 2 is a diagram explaining the content consumption manager in more detail. A user may enter a search query 132 into a computer 130 via a search engine. The user may work for a company Y. For example, the user may have an associated email address USER@COMPANY_Y.com.

In response to search query 132, the search engine may display links to content 112A and 112B on website1 and website2, respectively. The user may click on the link to website1. Website1 may download a web page to computer 130 that includes a link to a white paper. Website1 may include one or more web pages with CCM tags 110A that capture different events during the web session between website1 and computer 130. Website1 or another website may have downloaded a cookie onto a web browser operating on computer 130. The cookie may comprise an identifier X, such as a unique alphanumeric set of characters associated with the web browser on computer 130.

During the web session with website1, the user of computer 130 may click on a link to white paper 112A. In response to the mouse click, CCM tag 110A may download an event 108A to CCM 100. Event 108A may identify the cookie identifier X loaded on the web browser of computer 130. In addition, or alternatively, CCM tag 110A may capture a user name and/or email address entered into one or more web page fields during the web session. CCM tag 110 hashes the email address and includes the hashed email address in event 108A. Any identifier associated with the user is referred to generally as user X or user ID.

CCM tag 110A also may include a link in event 108A to the white paper downloaded from website1 to computer 130. For example, CCM tag 110A may capture the universal resource locator (URL) for white paper 112A. CCM tag 110A also may include an event type identifier in event 108A that identifies an action or activity associated with content 112A. For example, CCM tag 110A may insert an event type identifier into event 108A that indicates the user downloaded an electric document.

CCM tag 110A also may identify the launching platform for accessing content 112B. For example, CCM tag 110B may identify a link www.searchengine.com to the search engine used for accessing website1.

An event profiler 140 in CCM 100 forwards the URL identified in event 108A to a content analyzer 142. Content analyzer 142 generates a set of topics 136 associated with or suggested by white paper 112A. For example, topics 136 may include electric cars, cars, smart cars, electric batteries, etc. Each topic 136 may have an associated relevancy score indicating the relevancy of the topic in white paper 112A. Content analyzers that identify topics in documents are known to those skilled in the art and are therefore not described in further detail.

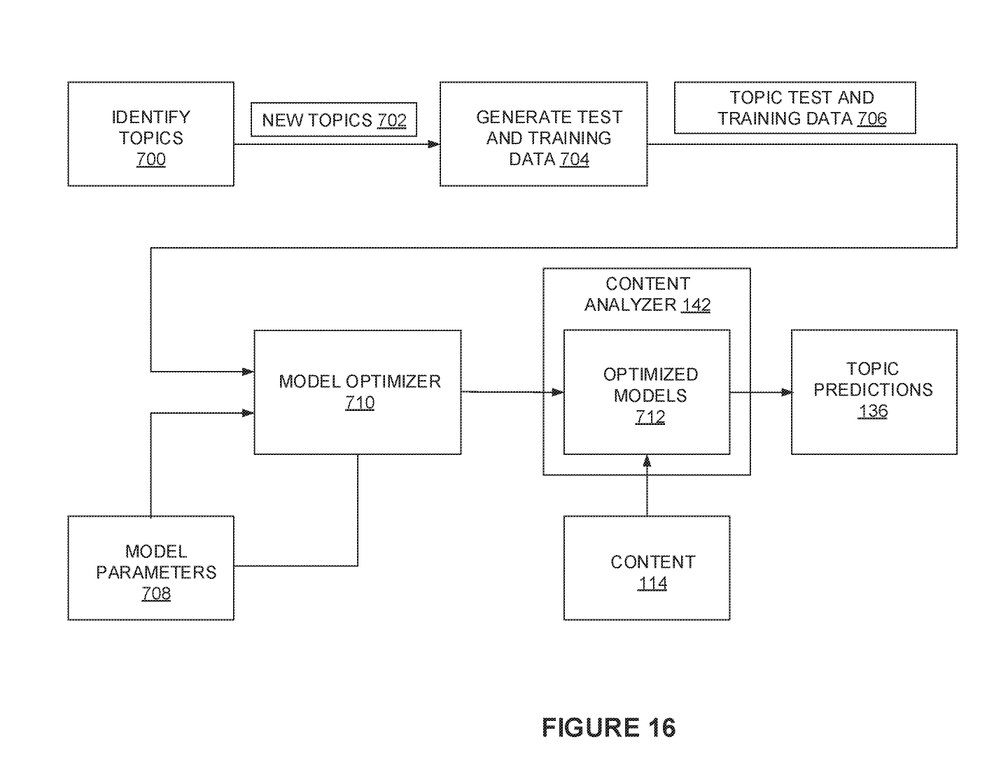

Content analyzer 142 may use a model optimizer 710 to generate an optimized set of model parameters that a topic characterization model uses to generate topics 136. In one example, model optimizer 710 also uses a distributed model training and testing scheme to more efficiently identify the optimized model parameter set. Model optimizer 710 is described below in FIGS. 16-20.

Event profiler 140 forwards the user ID, topics 136, event type, and any other data from event 108A to event processor 144. Event processor 144 may store personal information captured in event 108A in a personal database 148. For example, during the web session with website1, the user may have entered an employer company name into a web page form field. CCM tag 110A may copy the employer company name into event 108A. Alternatively, CCM 100 may identify the company name from a domain name of the user email address.

Event processor 144 may store other demographic information from event 108A in personal database 148, such as user job title, age, sex, geographic location (postal address), etc. In one example, some of the information in personal database 148 is hashed, such as the user ID and or any other personally identifiable information. Other information in personal database 148 may be anonymous to any specific user, such as company name and job title.

Event processor 144 builds a user intent vector 145 from topic vectors 136. Event processor 144 continuously updates user intent vector 145 based on other received events 108. For example, the search engine may display a second link to website2 in response to search query 132. User X may click on the second link and website2 may download a web page to computer 130 announcing the seminar on electric cars.

The web page downloaded by website2 also may include a CCM tag 110B. User X may register for the seminar during the web session with website2. CCM tag 110B may generate a second event 108B that includes the user ID: X, a URL link to the web page announcing the seminar, and an event type indicating the user registered for the electric car seminar advertised on the web page.

CCM tag 110B sends event 108B to CCM 100. Content analyzer 142 generates a second set of topics 136. Event 108B may contain additional personal information associated with user X. Event processor 144 may add the additional personal information to personal database 148.

Event processor 144 updates user intent vector 145 based on the second set of topics 136 identified for event 108B. Event processor 144 may add new topics to user intent vector 145 or may change the relevancy scores for existing topics. For example, topics identified in both event 108A and 108B may be assigned higher relevancy scores. Event processor 144 also may adjust relevancy scores based on the associated event type identified in events 108.

Publisher 118 may submit a search query 154 to CCM 100 via a user interface 152 on a computer 155. For example, search query 154 may ask WHO IS INTERESTED IN BUYING ELECTRIC CARS? A transporter 150 in CCM 100 searches user intent vectors 145 for electric car topics with high relevancy scores. Transporter 150 may identify user intent vector 145 for user X. Transporter 150 identifies user X and other users A, B, and C interested in electric cars in search results 156.

As mentioned above, the user IDs may be hashed and CCM 100 may not know the actual identities of users X, A, B, and C. CCM 100 may provide a segment of hashed user IDs X, A, B, and C to publisher 118 in response to query 154.

Publisher 118 may have a contact list 120 of users (FIG. 1). Publisher 118 may hash email addresses in contact list 120 and compare the hashed identifiers with the encrypted or hashed user IDs X, A, B, and C. Publisher 118 identifies the unencrypted email address for matching user identifiers. Publisher 118 then sends information related to electric cars to the email addresses of the identified user segment. For example, publisher 118 may send emails containing white papers, advertisements, articles, announcements, seminar notifications, or the like, or any combination thereof.

CCM 100 may provide other information in response to search query 154. For example, event processor 144 may aggregate user intent vectors 145 for users employed by the same company Y into a company intent vector. The company intent vector for company Y may indicate a strong interest in electric cars. Accordingly, CCM 100 may identify company Y in search results 156. By aggregating user intent vectors 145, CCM 100 can identify the intent of a company or other category without disclosing any specific user personal information, e.g., without regarding a user's online browsing activity.

CCM 100 continuously receives events 108 for different third party content. Event processor 144 may aggregate events 108 for a particular time period, such as for a current day, for the past week, or for the past 30 days. Event processor 144 then may identify trending topics 158 within that particular time period. For example, event processor 144 may identify the topics with the highest average relevancy values over the last 30 days.

Different filters 159 may be applied to the intent data stored in event database 146. For example, filters 159 may direct event processor 144 to identify users in a particular company Y that are interested in electric cars. In another example, filters 159 may direct event processor 144 to identify companies with less than 200 employees that are interested in electric cars.

Filters 159 also may direct event processor 144 to identify users with a particular job title that are interested in electric cars or identify users in a particular city that are interested in electric cars. CCM 100 may use any demographic information in personal database 148 for filtering query 154.

CCM 100 monitors content accessed from multiple different third party websites. This allows CCM 100 to better identify the current intent for a wider variety of users, companies, or any other demographics. CCM 100 may use hashed and/or other anonymous identifiers to maintain user privacy. CCM 100 further maintains user anonymity by identifying the intent of generic user segments, such as companies, marketing groups, geographic locations, or any other user demographics.

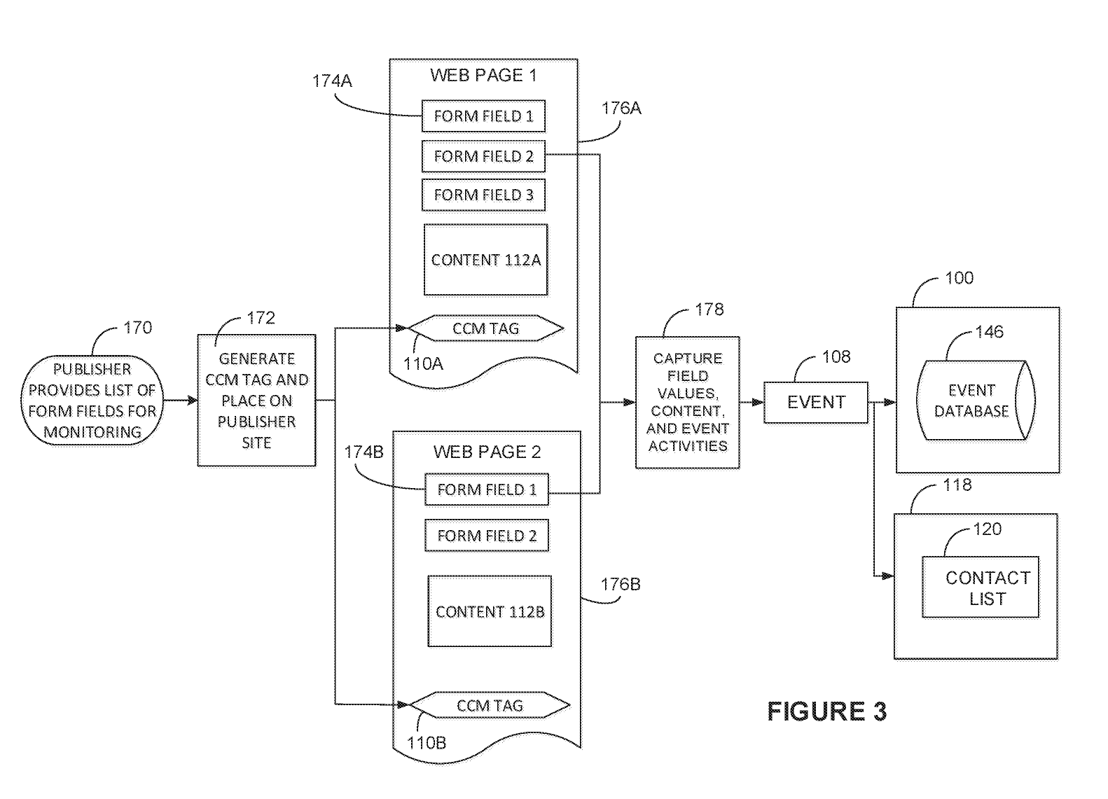

FIG. 3 depicts example operations performed by CCM tags. In operation 170, a publisher provides a list of form fields 174 for monitoring on web pages 176. In operation 172, CCM tags 110 are generated and loaded in web pages 176 on the publisher website. For example, CCM tag 110A is loaded onto a first web page 176A of the publisher website and a CCM tag 110B is loaded onto a second web page 176B of the publisher website. In one example, CCM tags 110 comprise JavaScript loaded into the web page document object model (DOM).

The publisher may download web pages 176, along with CCM tags 110, to user computers during web sessions. CCM tag 110A captures the data entered into some of form fields 174A and CCM tag 110B captures data entered into some of form fields 174B.

A user enters information into form fields 174A and 174B during the web session. For example, the user may enter an email address into one of form fields 174A during a user registration process. CCM tags 110 may capture the email address in operation 178, validate and hash the email address, and then send the hashed email address to CCM 100 in event 108.

CCM tags 100 may first confirm the email address includes a valid domain syntax and then use a hash algorithm to encode the valid email address string. CCM tags 110 also may capture other anonymous user identifiers, such as a cookie identifier. If no identifiers exist, CCM tag 110 may create a unique identifier.

CCM tags 110 may capture any information entered into fields 174. For example, CCM tags 110 also may capture user demographic data, such as company name, age, sex, postal address, etc. In one example, CCM tags 110 capture some the information for publisher contact list 120.

CCM tags 110 also may identify content 112 and associated event activities in operation 178. For example, CCM tag 110A may detect a user downloading a white paper 112A or registering for a seminar. CCM tag 110A captures the URL for white paper 112A and generates an event type identifier that identifies the event as a document download.

Depending on the application, CCM tag 110 in operation 178 sends the captured web session information in event 108 to publisher 118 or to CCM 100. For example, event 108 is sent to publisher 118 when CCM tag 110 is used for generating publisher contact list 120. Event 108 is sent to CCM 100 when CCM tag 110 is used for generating intent data.

CCM tags 110 may capture the web session information in response to the user leaving web page 176, existing one of form fields 174, selecting a submit icon, mousing out of one of form fields 174, a mouse click, an off focus, or any other user action. Note again that CCM 100 might never receive personally identifiable information (PII) since any PII data in event 108 is hashed by CCM tag 110.

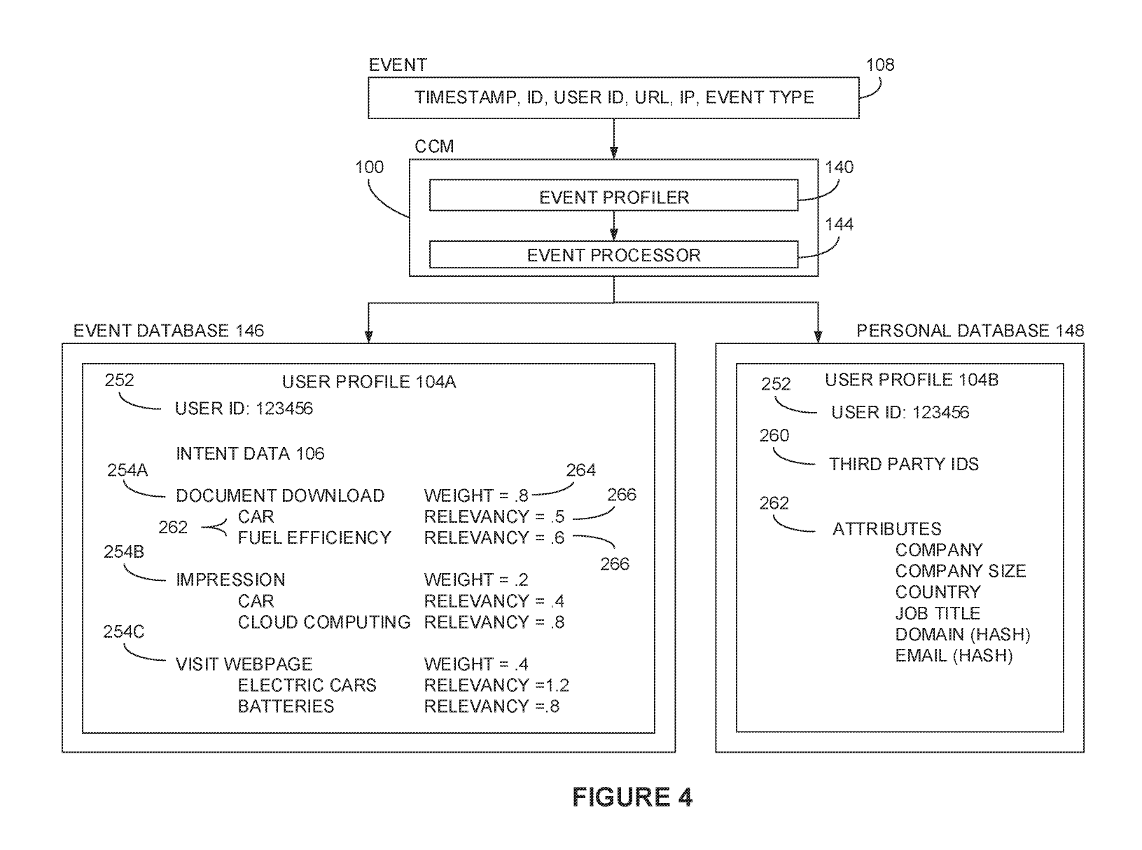

FIG. 4 is a diagram showing how the CCM generates intent data. A CCM tag may send a captured raw event 108 to CCM 100. For example, the CCM tag may send event 108 to CCM 100 in response to a user downloading a white paper. Event 108 may include a timestamp indicating when the white paper was downloaded, an identifier (ID) for event 108, a user ID associated with the user that downloaded the white paper, a URL for the downloaded white paper, and an IP address for the launching platform for the content. Event 108 also may include an event type indicating the user downloaded an electronic document.

Event profiler 140 and event processor 144 may generate intent data 106 from one or more events 108. Intent data 106 may be stored in a structured query language (SQL) database or non-SQL database. In one example, intent data 106 is stored in user profile 104A and includes a user ID 252 and associated event data 254.

Event data 254A is associated with a user downloading a white paper. Event profiler 140 identifies a car topic 262 and a fuel efficiency topic 262 in the white paper. Event profiler 140 may assign a 0.5 relevancy value to the car topic and assign a 0.6 relevancy value to the fuel efficiency topic.

Event processor 144 may assign a weight value 264 to event data 254A. Event processor 144 may assign larger a weight value 264 to more assertive events, such as downloading the white paper. Event processor 144 may assign a smaller weight value 264 to less assertive events, such as viewing a web page. Event processor 144 may assign other weight values 264 for viewing or downloading different types of media, such as downloading a text, video, audio, electronic books, on-line magazines and newspapers, etc.

CCM 100 may receive a second event 108 for a second piece of content accessed by the same user. CCM 100 generates and stores event data 254B for the second event 108 in user profile 104A. Event profiler 140 may identify a first car topic with a relevancy value of 0.4 and identify a second cloud computing topic with a relevancy value of 0.8 for the content associated with event data 254B. Event processor 144 may assign a weight value of 0.2 to event data 254B.

CCM 100 may receive a third event 108 for a third piece of content accessed by the same user. CCM 100 generates and stores event data 254C for the third event 108 in user profile 104A. Event profiler 140 identifies a first topic associated with electric cars with a relevancy value of 1.2 and identifies a second topic associated with batteries with a relevancy value of 0.8. Event processor 144 may assign a weight value of 0.4 to event data 254C.

Event data 254 and associated weighting values 264 may provide a better indicator of user interests/intent. For example, a user may complete forms on a publisher website indicating an interest in cloud computing. However, CCM 100 may receive events 108 for third party content accessed by the same user. Events 108 may indicate the user downloaded a whitepaper discussing electric cars and registered for a seminar related to electric cars.

CCM 100 generates intent data 106 based on received events 108. Relevancy values 266 in combination with weighting values 264 may indicate the user is highly interested in electric cars. Even though the user indicated an interest in cloud computing on the publisher website, CCM 100 determined from the third party content that the user was actually more interested in electric cars.

CCM 100 may store other personal user information from events 108 in user profile 104B. For example, event processor 144 may store third party identifiers 260 and attributes 262 associated with user ID 252. Third party identifiers 260 may include user names or any other identifiers used by third parties for identifying user 252. Attributes 262 may include an employer company name, company size, country, job title, hashed domain name, and/or hashed email addresses associated with user ID 252. Attributes 262 may be combined from different events 108 received from different websites accessed by the user. CCM 100 also may obtain different demographic data in user profile 104 from third party data sources (whether sourced online or offline).

An aggregator may use user profile 104 to update and/or aggregate intent data for different segments, such as publisher contact lists, companies, job titles, etc. The aggregator also may create snapshots of intent data 106 for selected time periods.

Event processor 144 may generate intent data 106 for both known and unknown users. For example, the user may access a web page and enter an email address into a form field in the web page. A CCM tag captures and hashes the email address and associates the hashed email address with user ID 252.

The user may not enter an email address into a form field. Alternatively, the CCM tag may capture an anonymous cookie ID in event 108. Event processor 144 then associates the cookie ID with user identifier 252. The user may clear the cookie or access data on a different computer. Event processor 144 may generate a different user identifier 252 and new intent data 106 for the same user.

The cookie ID may be used to create a de-identified cookie data set. The de-identified cookie data set then may be integrated with ad platforms or used for identifying destinations for target advertising.

CCM 100 may separately analyze intent data 106 for the different anonymous user IDs. If the user ever fills out a form providing an email address, event processor then may re-associate the different intent data 106 with the same user identifier 252.

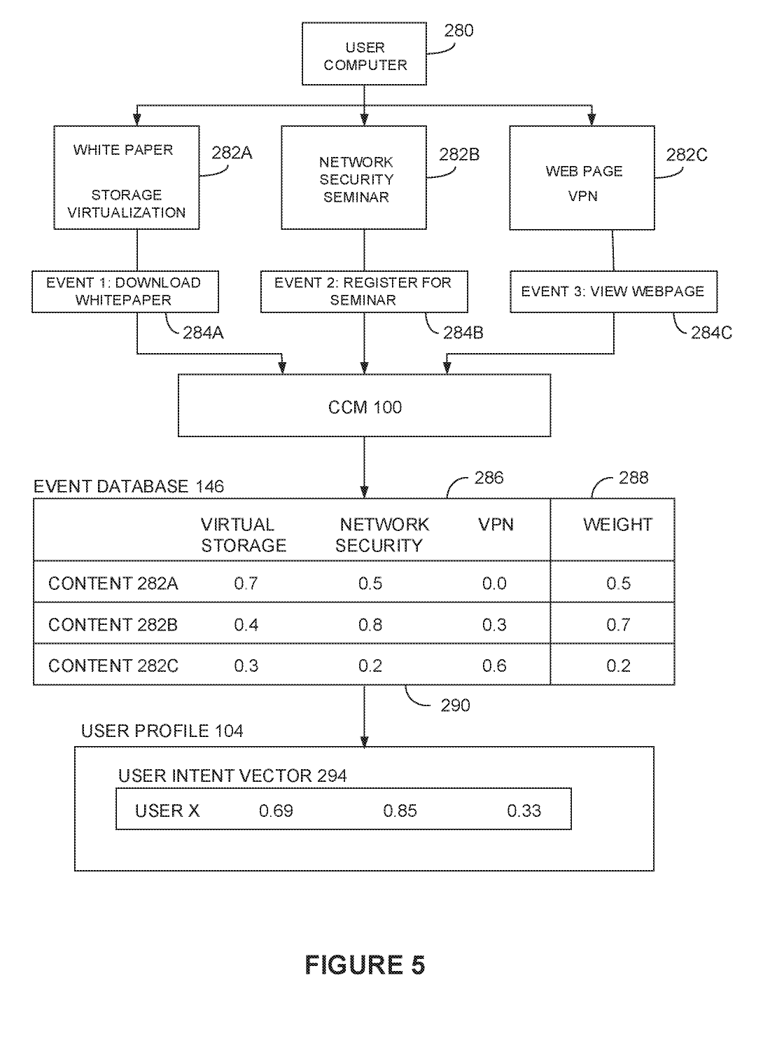

FIG. 5 depicts an example of how the CCM generates a user intent vector from the event data described above in FIG. 4. A user may use computer 280 to access different content 282. For example, the user may download a white paper 282A associated with storage virtualization, register for a network security seminar on a web page 282B, and view a web page article 282C related to virtual private networks (VPNs). Content 282A, 282B, and 282C may come from the same website or come from different websites.

The CCM tags discussed above capture three events 284A, 284B, and 284C associated with content 282A, 282B, and 282C, respectively. CCM 100 identifies topics 286 in content 282A, 282B, and/or 282C. Topics 286 include virtual storage, network security, and VPNs. CCM 100 assigns relevancy values 290 to topics 286 based on known algorithms. For example, relevancy values 290 may be assigned based on the number of times different associated keywords are identified in content 282.

CCM 100 assigns weight values 288 to content 282 based on the associated event activity. For example, CCM 100 assigns a relatively high weight value of 0.7 to a more assertive off-line activity, such as registering for the network security seminar. CCM 100 assigns a relatively low weight value of 0.2 to a more passive on-line activity, such as viewing the VPN web page.

CCM 100 generates a user intent vector 294 in user profile 104 based on the relevancy values 290. For example, CCM 100 may multiply relevancy values 290 by the associated weight values 288. CCM 100 then may sum together the weighted relevancy values for the same topics to generate user intent vector 294.

CCM 100 uses intent vector 294 to represent a user, represent content accessed by the user, represent user access activities associated with the content, and effectively represent the intent/interests of the user. In another embodiment, CCM 100 may assign each topic in user intent vector 294 a binary score of 1 or 0. CCM 100 may use other techniques for deriving user intent vector 294. For example, CCM 100 may weigh the relevancy values based on timestamps.

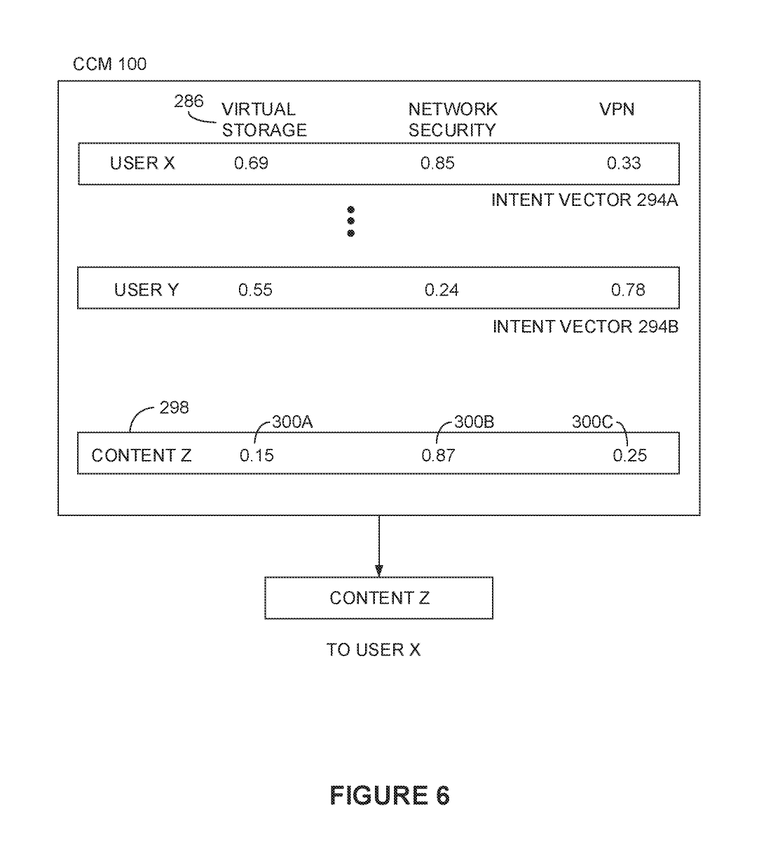

FIG. 6 depicts an example of how the CCM segments users. CCM 100 may generate user intent vectors 294A and 294B for two different users. A publisher may want to email content 298 to a segment of interested users. The publisher submits content 298 to CCM 100. CCM 100 identifies topics 286 and associated relevancy values 300 for content 298.

CCM 100 may use any variety of different algorithms to identify a segment of user intent vectors 294 associated with content 298. For example, relevancy value 300B indicates content 298 is primarily related to network security. CCM 100 may identify any user intent vectors 294 that include a network security topic with a relevancy value above a given threshold value.

In this example, assume the relevancy value threshold for the network security topic is 0.5. CCM 100 identifies user intent vector 294A as part of the segment of users satisfying the threshold value. Accordingly, CCM 100 sends the publisher of content 298 a contact segment that includes the user ID associated with user intent vector 294A. As mentioned above, the user ID may be a hashed email address, cookie ID, or some other encrypted or unencrypted identifier associated with the user.

In another example, CCM 100 calculates vector cross products between user intent vectors 294 and content 298. Any user intent vectors 294 that generate a cross product value above a given threshold value are identified by CCM 100 and sent to the publisher.

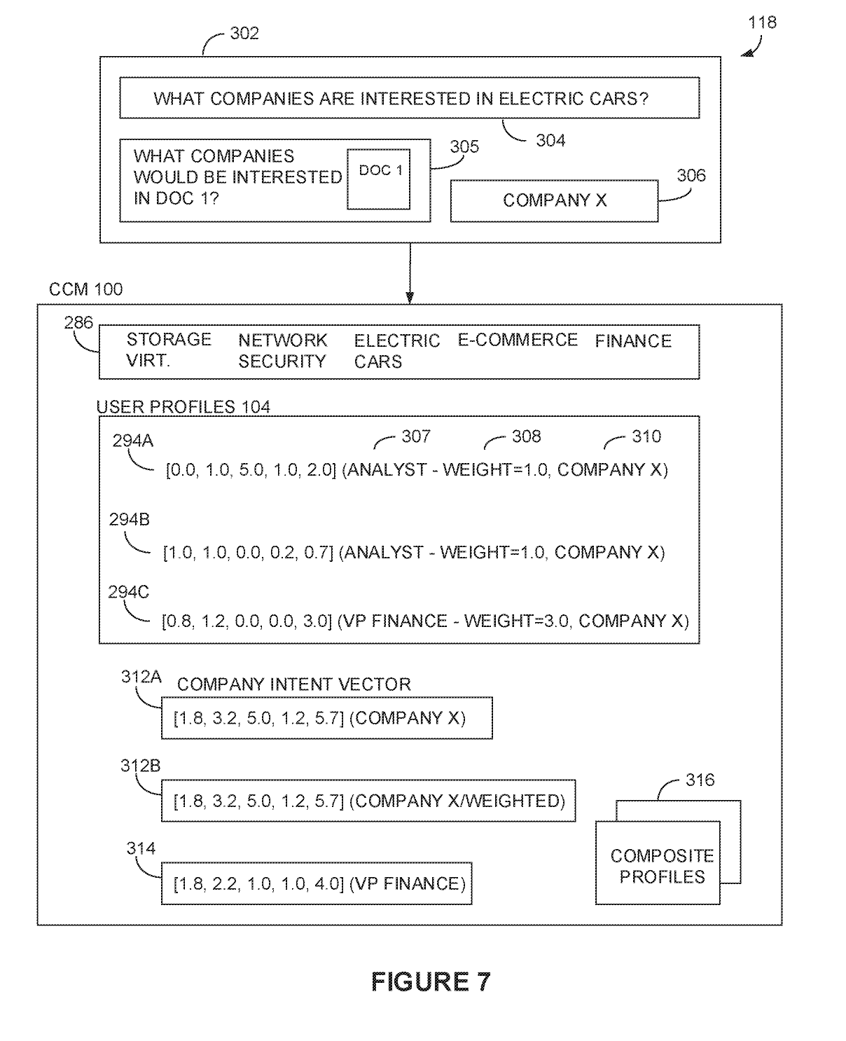

FIG. 7 depicts examples of how the CCM aggregates intent data. In this example, a publisher operating a computer 302 submits a search query 304 to CCM 100 asking what companies are interested in electric cars. In this example, CCM 100 associates five different topics 286 with user profiles 104. Topics 286 include storage virtualization, network security, electric cars, e-commerce, and finance.

CCM 100 generates user intent vectors 294 as described above in FIG. 6. User intent vectors 294 have associated personal information, such as a job title 307 and an employer company name 310. As explained above, users may provide personal information, such as employer name and job title in form fields when accessing a publisher or third party website.

The CCM tags described above capture and send the job title and employer name information to CCM 100. CCM 100 stores the job title and employer information in the associated user profile 104.

CCM 100 searches user profiles 104 and identifies three user intent vectors 294A, 294B, and 294C associated with the same employer name 310. CCM 100 determines that user intent vectors 294A and 294B are associated with a same job title of analyst and user intent vector 294C is associated with a job title of VP of finance.

In response to, or prior to, search query 304, CCM 100 generates a company intent vector 312A for company X. CCM 100 may generate company intent vector 312A by summing up the topic relevancy values for all of the user intent vectors 294 associated with company X.

In response to search query 304, CCM 100 identifies any company intent vectors 312 that include an electric car topic 286 with a relevancy value greater than a given threshold. For example, CCM 100 may identify any companies with relevancy values greater than 4.0. In this example, CCM 100 identifies company X in search results 306.

In one example, intent is identified for a company at a particular zip code, such as zip code 11201. CCM 100 may take customer supplied offline data, such as from a Customer Relationship Management (CRM) database, and identify the users that match the company and zip code 11201 to create a segment.

In another example, publisher 118 may enter a query 305 asking which companies are interested in a document (DOC 1) related to electric cars. Computer 302 submits query 305 and DOC 1 to CCM 100. CCM 100 generates a topic vector for DOC 1 and compares the DOC 1 topic vector with all known company intent vectors 312A.

CCM 100 may identify an electric car topic in the DOC 1 with high relevancy value and identify company intent vectors 312 with an electric car relevancy value above a given threshold. In another example, CCM 100 may perform a vector cross product between the DOC 1 topics and different company intent vectors 312. CCM 100 may identify the names of any companies with vector cross product values above a given threshold value and display the identified company names in search results 306.

CCM 100 may assign weight values 308 for different job titles. For example, an analyst may be assigned a weight value of 1.0 and a vice president (VP) may be assigned a weight value of 3.0. Weight values 308 may reflect purchasing authority associated with job titles 307. For example, a VP of finance may have higher authority for purchasing electric cars than an analyst. Weight values 308 may vary based on the relevance of the job title to the particular topic. For example, CCM 100 may assign an analyst a higher weight value 308 for research topics.

CCM 100 may generate a weighted company intent vector 312B based on weighting values 308. For example, CCM 100 may multiply the relevancy values for user intent vectors 294A and 294B by weighting value 1.0 and multiply the relevancy values for user intent vector 294C by weighting value 3.0. The weighted topic relevancy values for user intent vectors 294A, 294B, and 294C are then summed together to generate weighted company intent vector 312B.

CCM 100 may aggregate together intent vectors for other categories, such as job title. For example, CCM 100 may aggregate together all the user intent vectors 294 with VP of finance job titles into a VP of finance intent vector 314. Intent vector 314 identifies the topics of interest to VPs of finance.

CCM 100 also may perform searches based on job title or any other category. For example, publisher 118 may enter a query LIST VPs OF FINANCE INTERESTED IN ELECTRIC CARS? The CCM 100 identifies all of the user intent vectors 294 with associated VP finance job titles 307. CCM 100 then segments the group of user intent vectors 294 with electric car topic relevancy values above a given threshold value.

CCM 100 may generate composite profiles 316. Composite profiles 316 may contain specific information provided by a particular publisher or entity. For example, a first publisher may identify a user as VP of finance and a second publisher may identify the same user as VP of engineering. Composite profiles 316 may include other publisher provided information, such as company size, company location, company domain.

CCM 100 may use a first composite profile 316 when providing user segmentation for the first publisher. The first composite profile 316 may identify the user job title as VP of finance. CCM 100 may use a second composite profile 316 when providing user segmentation for the second publisher. The second composite profile 316 may identify the job title for the same user as VP of engineering. Composite profiles 316 are used in conjunction with user profiles 104 derived from other third party content.

In yet another example, CCM 100 may segment users based on event type. For example, CCM 100 may identify all the users that downloaded a particular article, or identify all of the users from a particular company that registered for a particular seminar.

### Consumption Scoring

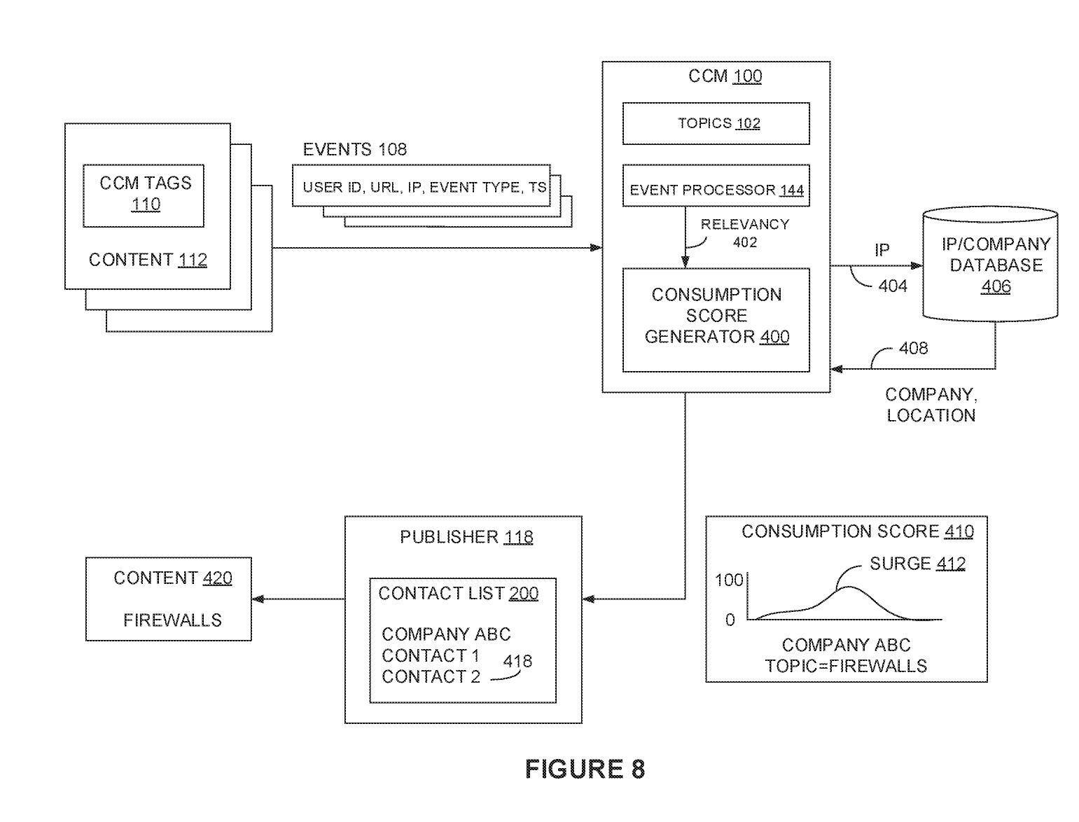

FIG. 8 depicts an example consumption score generator used in CCM 100. As explained above, CCM 100 may receive multiple events 108 associated with different content 112. For example, users may access web browsers, or any other application, to view content 112 on different websites. Content 112 may include any webpage, document, article, advertisement, or any other information viewable or audible by a user. For example, content 112 may include a webpage article or a document related to network firewalls.

CCM tag 110 may capture events 108 identifying content 112 accessed by a user during the web or application session. For example, events 108 may include a user identifier (USER ID), URL, IP address, event type, and time stamp (TS).

The user identifier may be a unique identifier CCM tag 110 generates for a specific user on a specific browser. The URL may be a link to content 112 accessed by the user during the web session. The IP address may be for a network device used by the user to access the Internet and content 112. As explained above, the event type may identify an action or activity associated with content 112. For example, the event type may indicate the user downloaded an electric document or displayed a webpage. The timestamp (TS) may identify a day and time the user accessed content 112.

Consumption score generator (CSG) 400 may access a IP/company database 406 to identify a company/entity and location 408 associated with IP address 404 in event 108. For example, existing services may provide databases 406 that identify the company and company address associated with IP addresses. The IP address and/or associated company or entity may be referred to generally as a domain. CSG 400 may generate metrics from events 108 for the different the companies 408 identified in database 406.

In another example, CCM tags 110 may include domain names in events 108. For example, a user may enter an email address into a web page field during a web session. CCM 100 may hash the email address or strip out the email domain address. CCM 100 may use the domain name to identify a particular company and location 408 from database 406.

As also described above, event processor 144 may generate relevancy scores 402 that indicate the relevancy of content 112 with different topics 102. For example, content 112 may include multiple words associate with topics 102. Event processor 144 may calculate relevancy scores 402 for content 112 based on the number and position words associated with a selected topic.

CSG 400 may calculate metrics from events 108 for particular companies 408. For example, CSG 400 may identify a group of events 108 for a current week that include the same IP address 404 associated with a same company and company location 408. CSG 400 may calculate a consumption score 410 for company 408 based on an average relevancy score 402 for the group of events 108. CSG 400 also may adjust the consumption score 410 based on the number of events 108 and the number of unique users generating the events 108.

CSG 400 may generate consumption scores 410 for company 408 for a series of time periods. CSG 400 may identify a surge 412 in consumption scores 410 based on changes in consumption scores 410 over a series of time periods. For example, CSG 400 may identify surge 412 based on changes in content relevancy, number of unique users, and number of events over several weeks. It has been discovered that surge 412 may correspond with a unique period when companies have heightened interest in a particular topic and are more likely to engage in direct solicitations related to that topic.

CCM 100 may send consumption scores 410 and/or any surge indicators 412 to publisher 118. Publisher 118 may store a contact list 200 that includes contacts 418 for company ABC. For example, contact list 200 may include email addresses or phone number for employees of company ABC. Publisher 118 may obtain contact list 200 from any source such as from a customer relationship management (CRM) system, commercial contact lists, personal contacts, third parties lead services, retail outlets, promotions or points of sale, or the like or any combination thereof.

In one example, CCM 100 may send weekly consumption scores 410 to publisher 118. In another example, publisher 118 may have CCM 100 only send surge notices 412 for companies on list 200 surging for particular topics 102.

Publisher 118 may send content 420 related to surge topics to contacts 418. For example, publisher 118 may send email advertisements, literature, or banner ads related to a firewalls to contacts 418. Alternatively, publisher 118 may call or send direct mailings regarding firewalls to contacts 418. Since CCM 100 identified surge 412 for a firewall topic at company ABC, contacts 418 at company ABC are more likely to be interested in reading and/or responding to content 420 related to firewalls. Thus, content 420 is more likely to have a higher impact and conversion rate when sent to contacts 418 of company ABC during surge 412.

In another example, publisher 118 may sell a particular product, such as firewalls. Publisher 118 may have a list of contacts 418 at company ABC known to be involved with purchasing firewall equipment. For example, contacts 418 may include the chief technology officer (CTO) and information technology (IT) manager at company ABC. CCM 100 may send publisher 118 a notification whenever a surge 412 is detected for firewalls at company ABC. Publisher 118 then may automatically send content 420 to specific contacts 418 at company ABC with job titles most likely to be interested in firewalls.

CCM 100 also may use consumption scores 410 for advertising verification. For example, CCM 100 may compare consumption scores 410 with advertising content 420 sent to companies or individuals. Advertising content 420 with a particular topic sent to companies or individuals with a high consumption score or surge for that same topic may receive higher advertising rates.

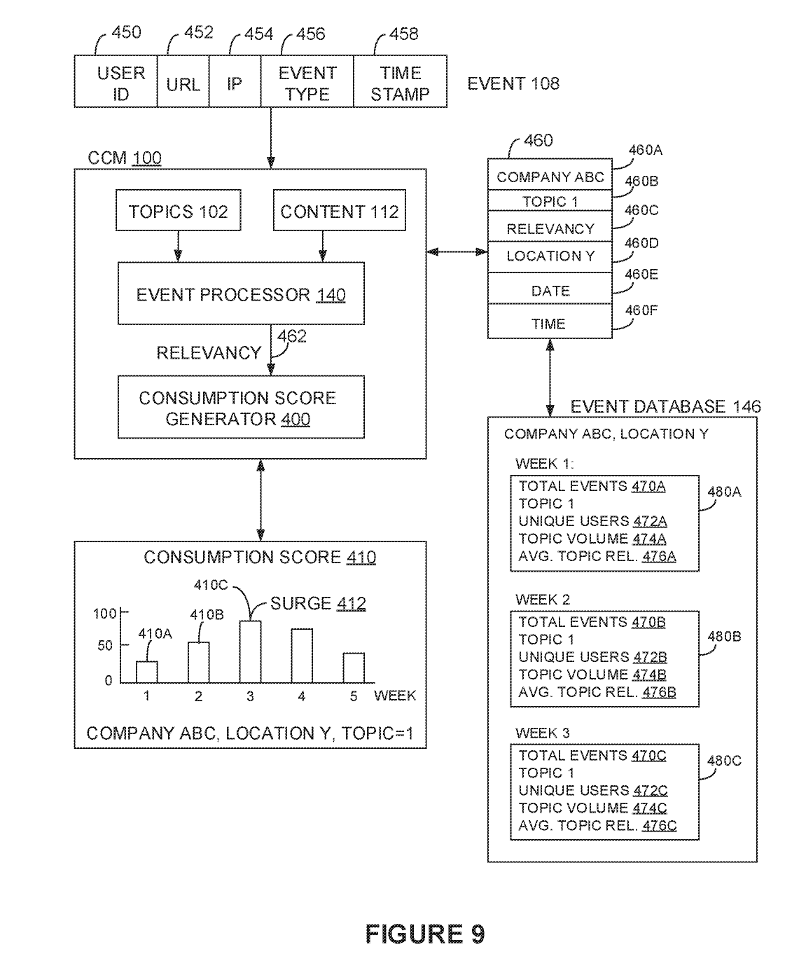

FIG. 9 shows in more detail how CCM 100 generates consumption scores 410. CCM 100 may receive millions of events from millions of different users associated with thousands of different domains every day. CCM 100 may accumulate the events 108 for different time periods, such as for each week. Week time periods are just one example and CCM 100 may accumulate events 108 for any selectable time period. CCM 100 also may store a set of topics 102 for any selectable subject matter. CCM 100 also may dynamically generate some of topics 102 based on the content identified in events 108 as described above.

Events 108 as mentioned above may include a user ID 450, URL 452, IP address 454, event type 456, and time stamp 458. Event processor 140 may identify content 112 located at URL 542 and select one of topics 102 for comparing with content 112. Event processor 140 may generate an associated relevancy score 462 indicating the relevancy of content 112 to selected topic 102. Relevancy score 462 may alternatively be referred to as a topic score.

CSG 400 may generate consumption data 460 from events 108. For example, CSG 400 may identify a company 460A associated with IP address 454. CSG 400 also may calculate a relevancy score 460C between content 112 and the selected topic 460B. CSG 400 also may identify a location 460D for with company 460A and identify a date 460E and time 460F when event 108 was detected.

CSG 400 may generate consumption metrics 480 from consumption data 460. For example, CSG 400 may calculate a total number of events 470A associated with company 460A (company ABC) and location 460D (location Y) for all topics during a first time period, such as for a first week. CSG 400 also may calculate the number of unique users 472A generating the events 108 associated with company ABC and topic 460B for the first week. CSG 400 may calculate for the first week a total number of events generated by company ABC for topic 460B (topic volume 474A). CSG 400 also may calculate an average topic relevancy 476A for the content accessed by company ABC and associated with topic 460B. CSG 400 may generate consumption metrics 480A-480C for sequential time periods, such as for three consecutive weeks.

CSG 400 may generate consumption scores 410 based on consumption metrics 480A-480C. For example, CSG 400 may generate a first consumption score 410A for week 1 and generate a second consumption score 410B for week 2 based in part on changes between consumption metrics 480A for week 1 and consumption metrics 480B for week 2. CSG 400 may generate a third consumption score 410C for week 3 based in part on changes between consumption metrics 480A, 480B, and 480C for weeks 1, 2, and 3, respectively. In one example, any consumption score 410 above as threshold value is identified as a surge 412.

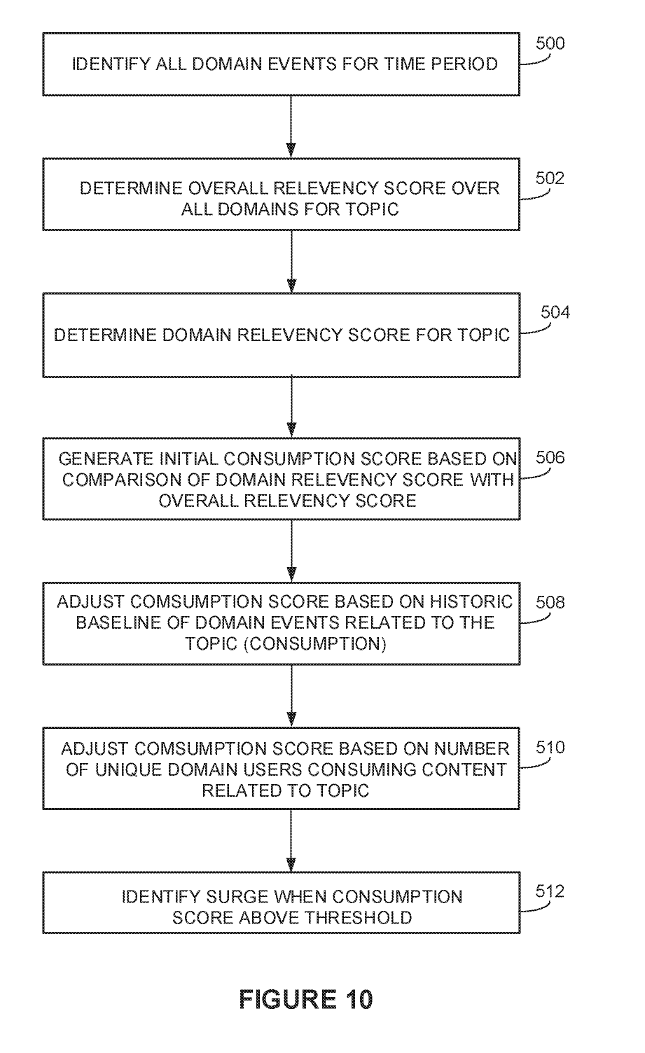

FIG. 10 depicts a process for identifying a surge in consumption scores. In operation 500, the CCM may identify all domain events for a given time period. For example, for a current week the CCM may accumulate all of the events for every IP address (domain) associated with every topic.

The CCM may use thresholds to select which domains to generate consumption scores. For example, for the current week the CCM may count the total number of events for a particular domain (domain level event count (DEC)) and count the total number of events for the domain at a particular location (metro level event count (DMEC)).

The CCM may calculate the consumption score for domains with a number of events more than a threshold (DEC>threshold). The threshold can vary based on the number of domains and the number of events. The CCM may use the second DMEC threshold to determine when to generate separate consumption scores for different domain locations. For example, the CCM may separate subgroups of company ABC events for the cities of Atlanta, New York, and Los Angeles that have each a number events DMEC above the second threshold.

In operation 502, the CCM may determine an overall relevancy score for all selected domains for each of the topics. For example, the CCM for the current week may calculate an overall average relevancy score for all domain events associated with the firewall topic.

In operation 504, the CCM may determine a relevancy score for a specific domain. For example, the CCM may identify a group of events having a same IP address associated with company ABC. The CCM may calculate an average domain relevancy score for the company ABC events associated with the firewall topic.

In operation 506, the CCM may generate an initial consumption score based on a comparison of the domain relevancy score with the overall relevancy score. For example, the CCM may assign an initial low consumption score when the domain relevancy score is a certain amount less than the overall relevancy score. The CCM may assign an initial medium consumption score larger than the low consumption score when the domain relevancy score is around the same value as the overall relevancy score. The CCM may assign an initial high consumption score larger than the medium consumption score when the domain relevancy score is a certain amount greater than the overall relevancy score. This is just one example, and the CCM may use any other type of comparison to determine the initial consumption scores for a domain/topic.

In operation 508, the CCM may adjust the consumption score based on a historic baseline of domain events related to the topic. This is alternatively referred to as consumption. For example, the CCM may calculate the number of domain events for company ABC associated with the firewall topic for several previous weeks.

The CCM may reduce the current week consumption score based on changes in the number of domain events over the previous weeks. For example, the CCM may reduce the initial consumption score when the number domain events fall in the current week and may not reduce the initial consumption score when the number of domain events rises in the current week.

In operation 510, the CCM may further adjust the consumption score based on the number of unique users consuming content associated with the topic. For example, the CCM for the current week may count the number of unique user IDs (unique users) for company ABC events associated with firewalls. The CCM may not reduce the initial consumption score when the number of unique users for firewall events increases from the prior week and may reduce the initial consumption score when the number of unique users drops from the previous week.

In operation 512, the CCM may identify surges based on the adjusted weekly consumption score. For example, the CCM may identify a surge when the adjusted consumption score is above a threshold.

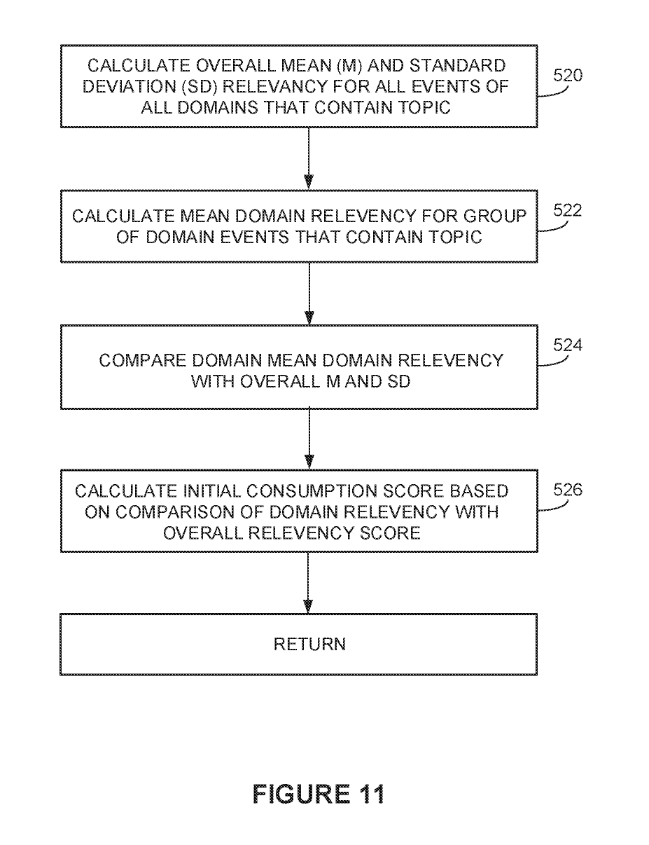

FIG. 11 depicts in more detail the process for generating an initial consumption score. It should be understood this is just one example scheme and a variety of other schemes also may be used.

In operation 520, the CCM may calculate an arithmetic mean (M) and standard deviation (SD) for each topic over all domains. The CCM may calculate M and SD either for all events for all domains that contain the topic, or alternatively for some representative (big enough) subset of the events that contain the topic. The CCM may calculate the overall mean and standard deviation as follows:

Mean:

$$M = \frac{1}{n} * {\sum }_{1}^{n} {x}_{i}$$

Standard deviation:

$$SD = \sqrt{\frac{1}{n - 1}} {\sum }_{1}^{n} {( {x}_{i} - M )}^{2}$$

Where xᵢ is a topic relevancy and n is a total number of events.

In operation 522, the CCM may calculate a mean (average) domain relevancy for each group of domain and/or domain/metro events for each topic. For example, for the past week the CCM may calculate the average relevancy for company ABC events for firewalls.

In operation 524, the CCM may compare the domain mean relevancy with the overall mean (M) relevancy and over standard deviation (SD) relevancy for all domains. For example, the CMM may assign three different levels to the domain mean relevancy (DMR).

Low: DMR<M−0.5*SD ˜33% of all values

Medium: M−0.5*SD<DMR<M+0.5*SD ˜33% of all values

High: DMR>M+0.5*SD ˜33% of all values

In operation 526, the CCM may calculate an initial consumption score for the domain/topic based on the above relevancy levels. For example, for the current week the CCM may assign one of the following initial consumption scores to the company ABC firewall topic. Again, this just one example of how the CCM may assign an initial consumption score to a domain/topic.

Relevancy=High: initial consumption score=100

Relevancy=Medium: Initial consumption score=70

Relevancy=Low: Initial consumption score 40.

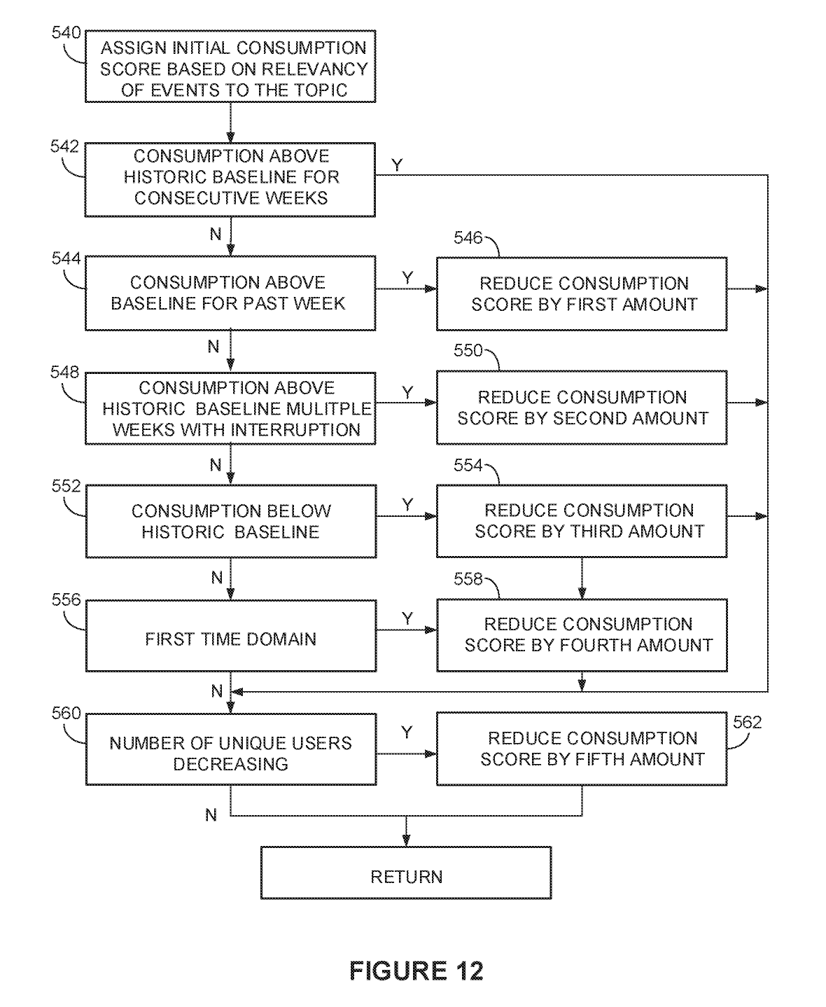

FIG. 12 depicts one example of how the CCM may adjust the initial consumption score. These are also just examples and the CCM may use other schemes for calculating a final consumption score. In operation 540, the CCM may assign an initial consumption score to the domain/location/topic as described above in FIG. 11.

The CCM may calculate a number of events for domain/location/topic for a current week. The number of events is alternatively referred to as consumption. The CCM also may calculate the number of domain/location/topic events for previous weeks and adjust the initial consumption score based on the comparison of current week consumption with consumption for previous weeks.

In operation 542, the CCM may determine if consumption for the current week is above historic baseline consumption for previous consecutive weeks. For example, the CCM may determine is the number of domain/location/topic events for the current week is higher than an average number of domain/location/topic events for at least the previous two weeks. If so, the CCM may not reduce the initial consumption value derived in FIG. 11.

If the current consumption is not higher than the average consumption in operation 542, the CCM in operation 544 may determine if the current consumption is above a historic baseline for the previous week. For example, the CCM may determine if the number of domain/location/topic events for current week is higher than the average number of domain/location/topic events for the previous week. If so, the CCM in operation 546 may reduce the initial consumption score by a first amount.

If the current consumption is not above than the previous week consumption in operation 544, the CCM in operation 548 may determine if the current consumption is above the historic consumption baseline but with interruption. For example, the CCM may determine if the number of domain/location/topic events has fallen and then risen over recent weeks. If so, the CCM in operation 550 may reduce the initial consumption score by a second amount.

If the current consumption is not above than the historic interrupted baseline in operation 548, the CCM in operation 552 may determine if the consumption is below the historic consumption baseline. For example, the CCM may determine if the current number of domain/location/topic events is lower than the previous week. If so, the CCM in operation 554 may reduce the initial consumption score by a third amount.

If the current consumption is above the historic base line in operation 552, the CCM in operation 556 may determine if the consumption is for a first time domain. For example, the CCM may determine the consumption score is being calculated for a new company or for a company that did not previously have enough events to qualify for calculating a consumption score. If so, the CCM in operation 558 may reduce the initial consumption score by a fourth amount.

In one example, the CCM may reduce the initial consumption score by the following amounts. This of course is just an example and the CCM may use any values and factors to adjust the consumption score.
Consumption above historic baseline consecutive weeks (operation 542).—0
Consumption above historic baseline past week (operation 544).—20 (first amount).
Consumption above historic baseline for multiple weeks with interruption (operation 548)—30 (second amount).
Consumption below historic baseline (operation 552).—40 (third amount).
First time domain (domain/metro) observed (operation 556).—30 (fourth amount).

As explained above, the CCM also may adjust the initial consumption score based on the number of unique users. The CCM tags 110 in FIG. 8 may include cookies placed in web browsers that have unique identifiers. The cookies may assign the unique identifiers to the events captured on the web browser. Therefore, each unique identifier may generally represent a web browser for a unique user. The CCM may identify the number of unique identifiers for the domain/location/topic as the number of unique users. The number of unique users may provide an indication of the number of different domain users interested in the topic.

In operation 560, the CCM may compare the number of unique users for the domain/location/topic for the current week with the number of unique users for the previous week. The CCM may not reduce the consumption score if the number of unique users increases over the previous week. When the number of unique users decrease, the CCM in operation 562 may further reduce the consumption score by a fifth amount. For example, the CCM may reduce the consumption score by 10.

The CCM may normalize the consumption score for slower event days, such as weekends. Again, the CCM may use different time periods for generating the consumption scores, such as each month, week, day, hour, etc. The consumption scores above a threshold are identified as a surge or spike and may represent a velocity or acceleration in the interest of a company or individual in a particular topic. The surge may indicate the company or individual is more likely to engage with a publisher who presents content similar to the surge topic.

### Consumption DNA

One advantage of domain based surge detection is that a surge can be identified for a company without using personally identifiable information (PII) of the company employees. The CCM derives the surge data based on a company IP address without using PII associated with the users generating the events.

In another example, the user may provide PII information during web sessions. For example, the user may agree to enter their email address into a form prior to accessing content. As described above, the CCM may hash the PII information and include the encrypted PII information either with company consumption scores or with individual consumption scores.

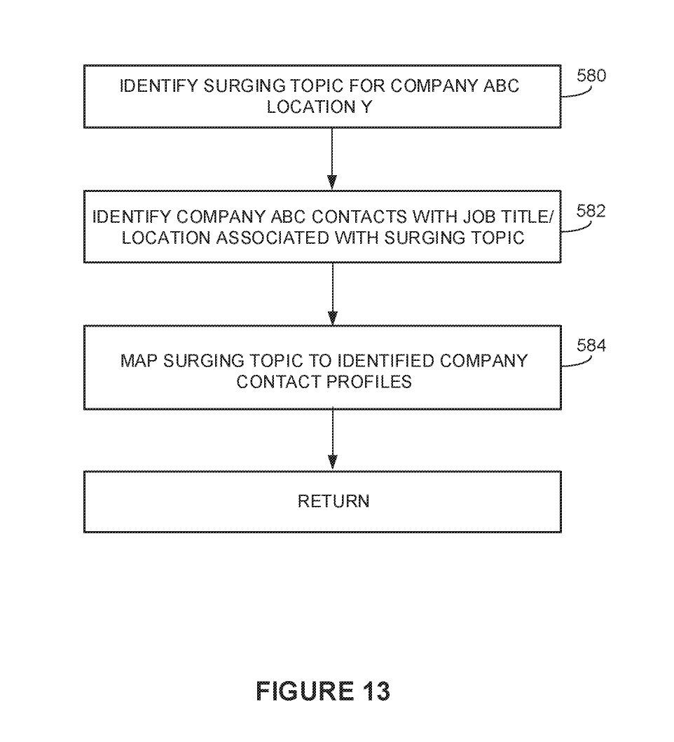

FIG. 13 shows one example process for mapping domain consumption data to individuals. In operation 580, the CCM may identify a surging topic for company ABC at location Y as described above. For example, the CCM may identify a surge for company ABC in New York for firewalls.

In operation 582, the CCM may identify users associated with company ABC. As mentioned above, some employees at company ABC may have entered personal contact information, including their office location\ and/or job titles into fields of web pages during events 108. In another example, a publisher or other party may obtain contact information for employees of company ABC from CRM customer profiles or third party lists.

Either way, the CCM or publisher may obtain a list of employees/users associated with company ABC at location Y. The list also may include job titles and locations for some of the employees/users. The CCM or publisher may compare the surge topic with the employee job titles. For example, the CCM or publisher may determine that the surging firewall topic is mostly relevant to users with a job title such as engineer, chief technical officer (CTO), or information technology (IT).

In operation 584, the CCM or publisher maps the surging firewall topic to profiles of the identified employees of company ABC. In another example, the CCM or publisher may not be as discretionary and map the firewall surge to any user associated with company ABC. The CCM or publisher then may direct content associated with the surging topic to the identified users. For example, the publisher may direct banner ads or emails for firewall seminars, products, and/or services to the identified users.

Consumption data identified for individual users is alternatively referred to as Dino DNA and the general domain consumption data is alternatively referred to as frog DNA. Associating domain consumption and surge data with individual users associated with the domain may increase conversion rates by providing more direct contact to users more likely interested in the topic.

### Intent Measurement

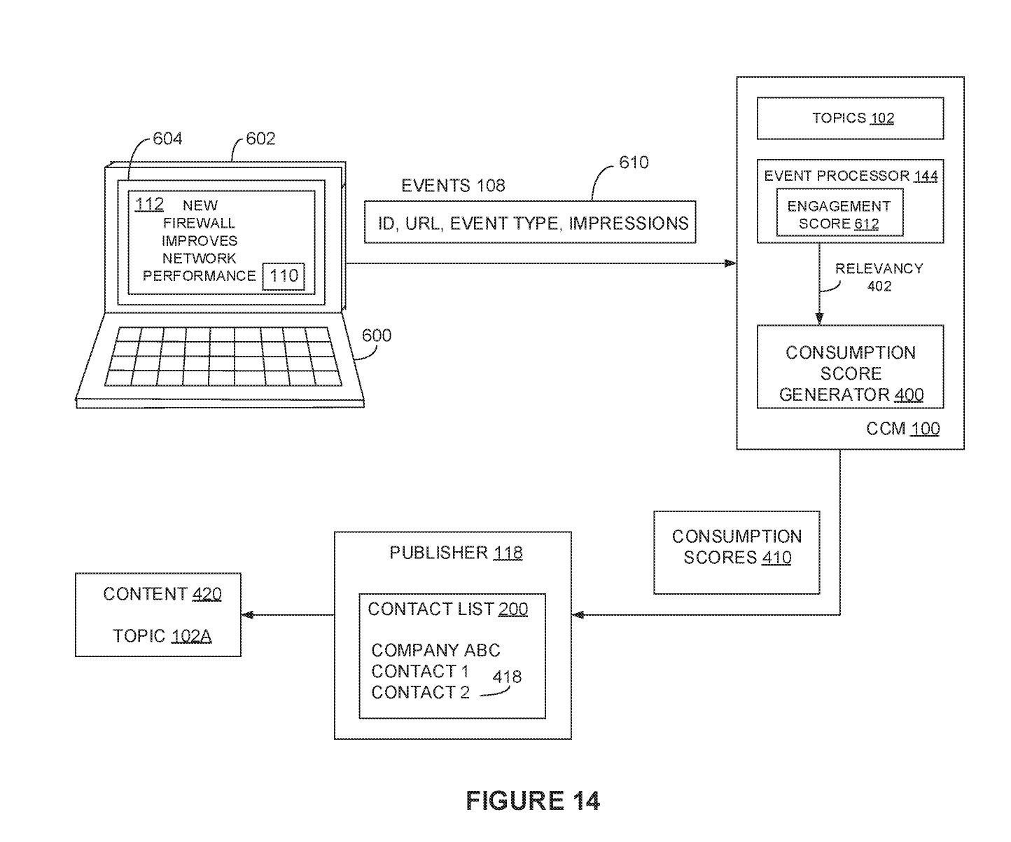

FIG. 14 depicts how CCM 100 may calculate consumption scores based on user engagement. A computer 600 may comprise a laptop, smart phone, tablet or any other device for accessing content 112. In this example, a user may open a web browser 604 on a screen 602 of computer 600. CCM tag 110 may operate within web browser 604 and monitor user web sessions. As explained above, CCM tag 110 may generate events 108 for the web session that include an identifier (ID), a URL for content 112, and an event type that identifies an action or activity associated with content 112. For example, CCM tag 110 may add an event type identifier into event 108 indicating the user downloaded an electric document.

In one example, CCM tag 110 also may generate a set of impressions 610 indicating actions taken by the user while viewing content 112. For example, impressions 610 may indicate how long the user dwelled on content 112 and/or how the user scrolled through content 112. Impressions 610 may indicate a level of engagement or interest the user has in content 112. For example, the user may spend more time on the web page and scroll through web page at a slower speed when the user is more interested in the content 112.

CCM 100 may calculate an engagement score 612 for content 112 based on impressions 610. CCM 100 may use engagement score 612 to adjust a relevancy score 402 for content 112. For example, CCM 100 may calculate a larger engagement score 612 when the user spends a larger amount of time carefully paging through content 112. CCM 100 then may increase relevancy score 402 of content 112 based on the larger engagement score 612. CSG 400 may adjust consumption scores 410 based on the increased relevancy 402 to more accurately identify domain surge topics. For example, a larger engagement score 612 may produce a larger relevancy 402 that produces a larger consumption score 410.

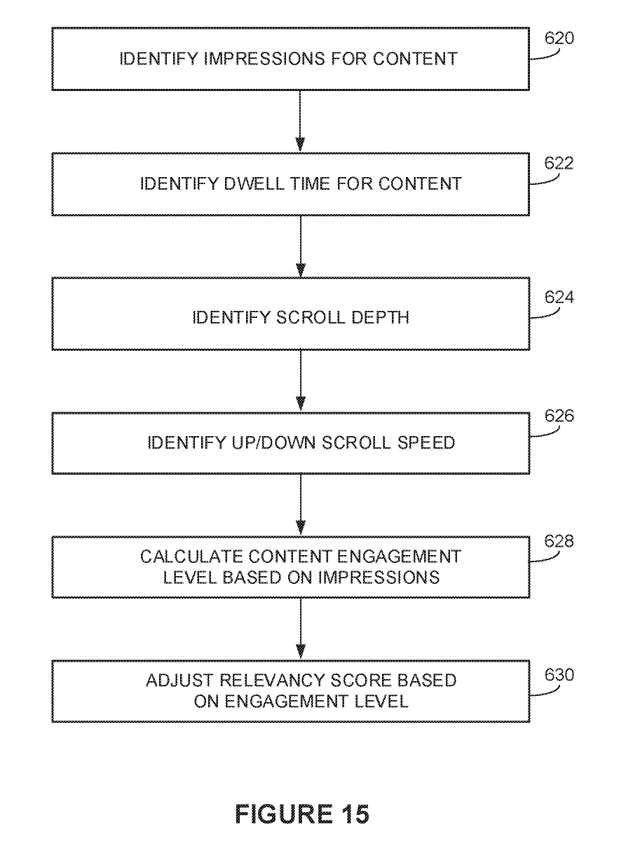

FIG. 15 depicts an example process for calculating the engagement score for content. In operation 620, the CCM may receive events that include content impressions. For example, the impressions may indicate any user interaction with content including tab selections that switch to different pages, page movements, mouse page scrolls, mouse clicks, mouse movements, scroll bar page scrolls, keyboard page movements, touch screen page scrolls, or any other content movement or content display indicator.

In operation 622, the CCM may identify the content dwell time. The dwell time may indicate how long the user actively views a page of content. In one example, tag 110 may stop a dwell time counter when the user changes page tabs or becomes inactive on a page. Tag 110 may start the dwell time counter again when the user starts scrolling with a mouse or starts tabbing.

In operation 624, the CCM may identify from the events a scroll depth for the content. For example, the CCM may determine how much of a page the user scrolled through or reviewed. In one example, the CCM tag or CCM may convert a pixel count on the screen into a percentage of the page.

In operation 626, the CCM may identify an up/down scroll speed. For example, dragging a scroll bar may correspond with a fast scroll speed and indicate the user has less interest in the content. Using a mouse wheel to scroll through content may correspond with a slower scroll speed and indicate the user is more interested in the content.

The CCM may assign higher values to impressions that indicate a higher user interest and assign lower values to impressions that indicate lower user interest. For example, the CCM may assign a larger value in operation 622 when the user spends more time actively dwelling on a page and may assign a smaller value when the user spends less time actively dwelling on a page.

In operation 628, the CCM may calculate the content engagement score based on the values derived in operations 622-628. For example, the CCM may add together and normalize the different values derived in operations 622-628.

In operation 630, the CCM may adjust content relevancy values described above in FIGS. 1-7 based on the content engagement score. For example, the CCM may increase the relevancy value when the content has a high engagement score and decrease the relevancy for a lower engagement score.

CCM 100 or CCM tag 110 in FIG. 14 may adjust the values assigned in operations 622-626 based on the type of device 600 used for viewing the content. For example, the dwell times, scroll depths, and scroll speeds, may vary between smart phone, tablets, laptops and desktop computers. CCM 100 or tag 110 may normalize or scale the impression values so different devices provide similar relative user engagement results.

### Model Optimization

FIG. 16 shows model optimizer 710 used in content consumption monitor 100 as shown above in FIG. 2. Model optimizer 710 may improve topic predictions 136 generated by a topic classification (TC) model 712 used by content analyzer 142. TC model 712 may refer to any analytic tool used for detecting topics in content and in at least one example may refer to an analytic tool that generates topic prediction values 136 that predict the likelihood content 114 refers to different topics 702.

In a first operation 700, a set of topics 702 may be identified. For example, a company may identify a set of topics 702 related to products or services the company is interested in selling to consumers. Topics 702 may include any subject or include any information that an entity wishes to identify in content 114. In one example, an entity may wish to identify users that access content 114 that includes particular topics 702 as described above.

Operation 704 generates a set of training and test data 706 for training and testing model 712. For example, a technician may select a sample set of webpages, white papers, technical documents, etc. that discuss or refer to selected topics 702. Training and test data 706 may use different words, phrases, contexts, terminologies, etc. to describe or discuss topics 702. Model optimizer 710 may generate model parameters 708 for training model 712. For example, model parameters 708 may specify a number of words, content length, word vectors, epochs, etc. Model optimizer 710 uses model parameters 708 to train model 712 with training data 706. Generally, training topic models with training data is known to those skilled in the art and is therefore not explained in further detail.

It may take a substantial amount of time to generate an optimized set of model parameters 708. For example, a natural language processing system may use hundreds of model parameters 708 and take several hours to train topic model 712 for a topic taxonomy or specific corpus. A brute force method may train model 712 with incremental changes in each model parameter 708 until model 712 provides sufficient accuracy. Another technique may randomly select model parameter values and take hours to produce a model 712 that provides a desired performance level.

Model optimizer 710 may use a Bayesian optimization to more efficiently identify optimal model parameters 708 in a multi-dimensional parameter space. Model optimizer 710 may use a Bayesian optimization on multiple sets of model parameters with known performance values to predict a next improved set of model parameters. Model optimizer 710 may use a Bayesian optimization in combination with a distributed model training and testing architecture to more quickly identify a set of model parameters 708 that optimize the topic classification performance of model 712.

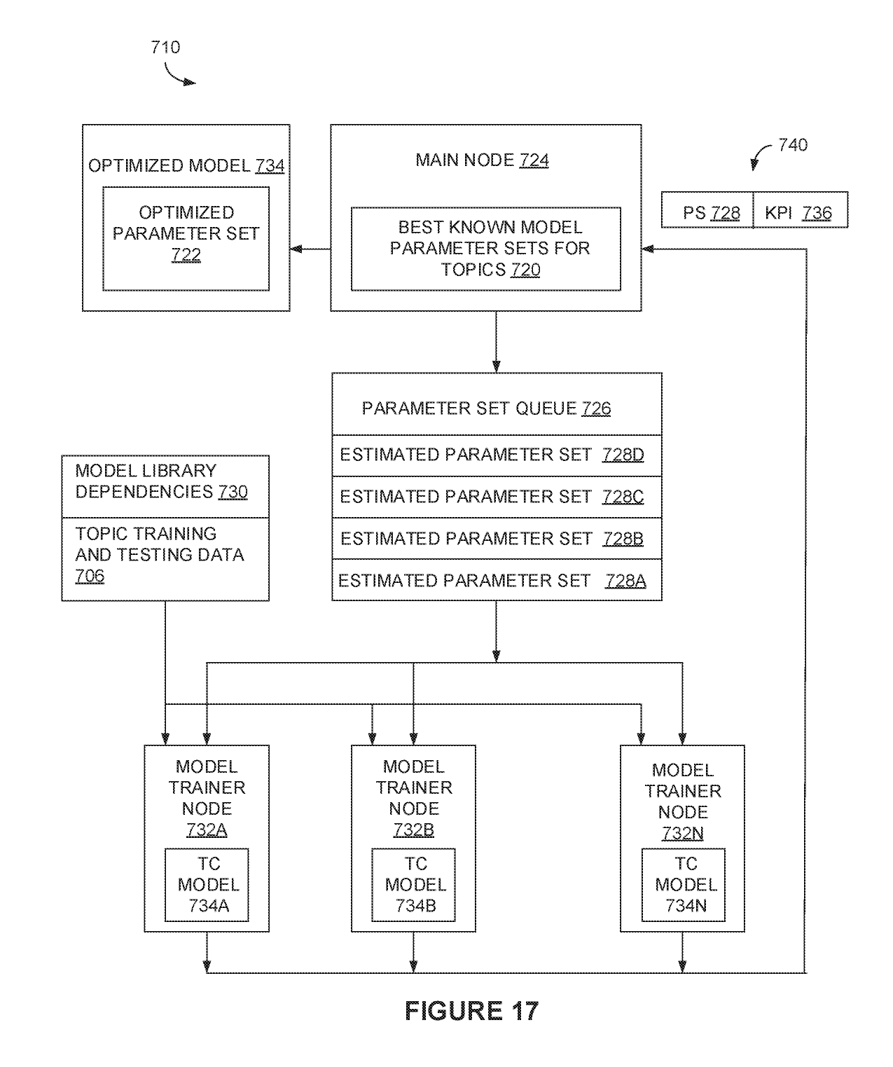

FIG. 17 shows model optimizer 710 in more detail. Model optimizer 710 may start with a best-known model parameter set 720 for the selected topics. For example, model optimizer 710 may use a previous model parameter set as initial guesses for generating a new parameter set for a new set of topics. Additionally, model optimizer 710 may use a model parameter set provided by a human operator. In another example, model optimizer 710 may use a predefined default set of model parameters 720.

A main node 724 uses the best-known parameter set 720 to predict or make an initial Bayesian guess at a more optimized estimated parameter set 728. For example, main node 724 may use Bayesian optimization to estimate or guess a first parameter set 728A for use with topic classification model 734. Bayesian optimization is described in Practical Bayesian Optimization of Machine Learning Algorithms, by Jasper Snoek, Hugo Larochelle, and Ryan P. Adams, Aug. 29, 2012, which is herein incorporated by reference in its entirety. Bayesian optimization is known to those skilled in the art and is therefore not described in further detail.

Estimated parameter set 728A is downloaded by one of trainer nodes 732A-732N. Each model trainer node 732 may include a software image that includes model library dependencies 730 used by TC model 734. The software image also may include training and testing data 706. Topic training and testing data 706 may contain content related to the selected topics. For example, topic training and testing data 706 may include webpages, white papers, text, news articles, online product literature, sales content, etc. describing one or more topics.

Topic training and testing data 706 also may include topic labels that model trainer nodes 732 use to determine how well TC models 734 predict the correct topics with parameter sets 728. The topic labels are associated with the content in the training and test dataset and allow human-based labeling of particular examples of content. A relatively small set of content may be used as test data and the rest of data 706 may be used for training TC models 734. In one example, model optimizer 710 may distribute model trainer nodes 732 on one or more nodes on Google Container Engine service.

Main node 724 may communicate with distributed model trainer nodes 732 via a parameter set queue 726. Main node 724 may place each estimated parameter set 728A-728D on the top of queue 726. Each model trainer node 732 may take a next available estimated parameter set 728 from the bottom of queue 726. For example, a first model trainer node 732A may extract the next estimated parameter set 728A from the bottom of queue 726 via a publish-subscribe protocol, such as Google PubSub service. After parameter set 728A is extracted from the bottom of queue 726 by model trainer node 732A, a next lowest parameter set 728B is extracted from the bottom of queue 726 by a next available model trainer node 732B or 732N, etc.

In other words, queue 726 may operate similar to a first in-first out queue where the master node pushes the estimated parameter sets on top of the queue and the estimated parameter sets move sequentially down the queue and are pulled out of a bottom end of the queue by the training nodes. Of course, other types of priority schemes may be used for processing estimated parameter sets 728.

Each model trainer node 732 uses their downloaded estimated parameter set 728 to train an associated TC model 734. For example, model trainer node 732A may download estimated parameter set 728A to train TC model 734A and model trainer node 732B may download estimated parameter set 728B to train TC model 734B.

Training TC model 734A may include identifying term frequencies, calculating inverse document frequency, matrix factorization, semantic analysis, and latent Dirichlet allocation (LDA). One example technique for training TC models is described in A Comparison of Event Models for Naive Bayes Text Classification by Andrew McCallum and Kamal Nigam, which is incorporated by reference in its entirety.

TC models 734A-734N generate topic predictions from test data 706 and compare the topics predictions with a known set of topics identified for test data 706. Model trainer nodes 732 then generate key performance indicators (KPIs/performance scores) 736 based on the comparison of the predicted topics with the known topics. Correctly predicted topics may increase the performance scores and incorrectly predicted topics may reduce the performance scores.

Model trainer nodes 732 generate result pairs 740 that include model performance value 736 for an associated estimated parameter set 728. The result pair 740 is fed back into the best-known parameter sets 720. Once a result pair 740 is generated, the model trainer node 732 may download the next available estimated parameter set 728 from the bottom of queue 726.

Main node 724 uses the result pairs 740 received from model trainer nodes 732 to generate a next estimated parameter set 728D. For example, main node 724 may use Bayesian optimization to try and derive a new parameter set 728D that improves the previously generated model performance value 736. Main node 724 places the new estimated parameter set 728D on the top of queue 726 for subsequent processing by one of model trainer nodes 732.

At some point, main node 724 identifies a convergence of performance values 736 or identifies a performance value 736 that reaches a threshold value. Main node 724 identifies the estimated parameter set that produces the converged or threshold performance value 736 as the optimized model parameter set 722. Model optimizer 710 uses the TC model 734 with the optimized model parameter set 722 in content analyzer 142 of FIG. 2 to generate topic predictions 136. Model optimizer 710 may conduct a new model optimization for any topic taxonomy update or for any newly identified topic.

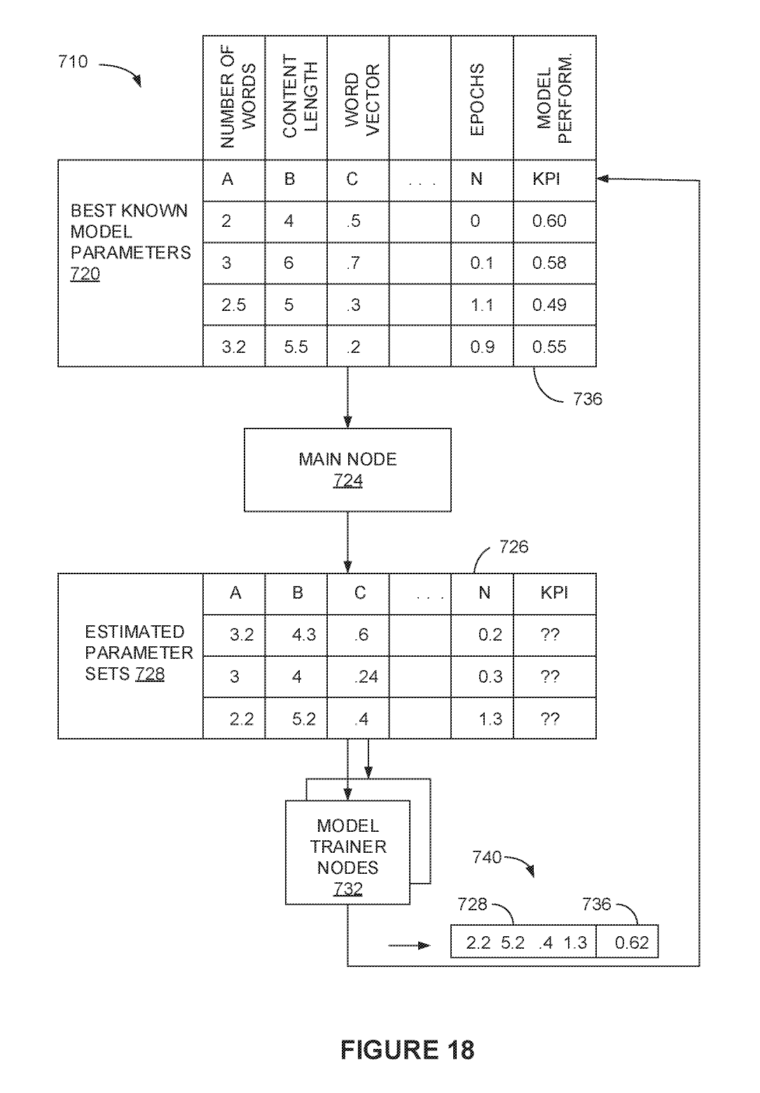

FIG. 18 shows how the model optimizer derives an estimated parameter set. As described above, main node 724 derives estimated parameter sets 728 from a best-known set of model parameters 720 for the selected topics. Some example model parameters 720 may include a word n-grams, word vector size, and epochs.

The word n-grams may define the maximum number of consecutive words used to tokenize the document, the word vector size may define the dimension of the word representation. Each word contained in training content may be represented as a vector, the length of the vector may represent the amount of information that vector contains.

The word vector may include information like grammar, semantic, higher concepts, etc. The word vector defines how the model looks across a piece of content and defines how the model converts data into a numerical representation. For example, the word vector is used to understand relationships between verb tense, male-female, countries, etc. The parameter set identifies the sizes and dimensions that the model uses for building the word vectors. One example technique for generating word vectors is described in Efficient Estimation of Word Representations in Vector Space by Tomas Mikolov, Greg Corrado, Kai Chen, and Jeffrey Dean, Sep. 7, 2013, which is incorporated by reference in its entirety.

Main node 724 may perform a Bayesian optimization on model parameters 720 to generate a next estimated parameter set 728. Main node 724 pushes the next estimated parameter set 728 onto the top of queue 726 for distribution to one of the multiple different model trainer nodes 732 as described above. Each model training node 732 trains the associated TC model using the estimated parameter set 728 downloaded from the bottom of queue 726.

Training nodes 732 output result pairs 740 that includes model performance value 736 for an associated TC model 734 and the estimated parameter set 728 used for training TC model 734. Result pairs 740 are sent back to main node 724 and added to existing parameter sets 720. Main node 724 then may generate a new estimated parameter set 728 based on the new group of all known parameter sets 720. In another example, result pairs 740 may replace one of the previous best-known model parameter sets 720. For example, result pair 740 may replace one of parameter sets 720 with a lowest performance value 736 or an oldest time stamp.

Model optimizer 710 may repeat this optimization process until model performance values 736 converge or reach a threshold value. In other example, model optimizer 710 may repeat the optimization process for a threshold time period or for a threshold number of iterations. Model optimizer 710 may use the trained TC model with the highest model performance value 736 to identify topics in the content consumption monitor.

As mentioned above, model training may use large processing bandwidth. Distributing model training to multiple parallel operating training nodes 732 may substantially reduce overall processing time for deriving optimized TC models. By using a Bayesian optimization, main node 724 also may reduce the number of model training iterations needed for identifying the parameter set 728 that produces a desired model performance value 736.

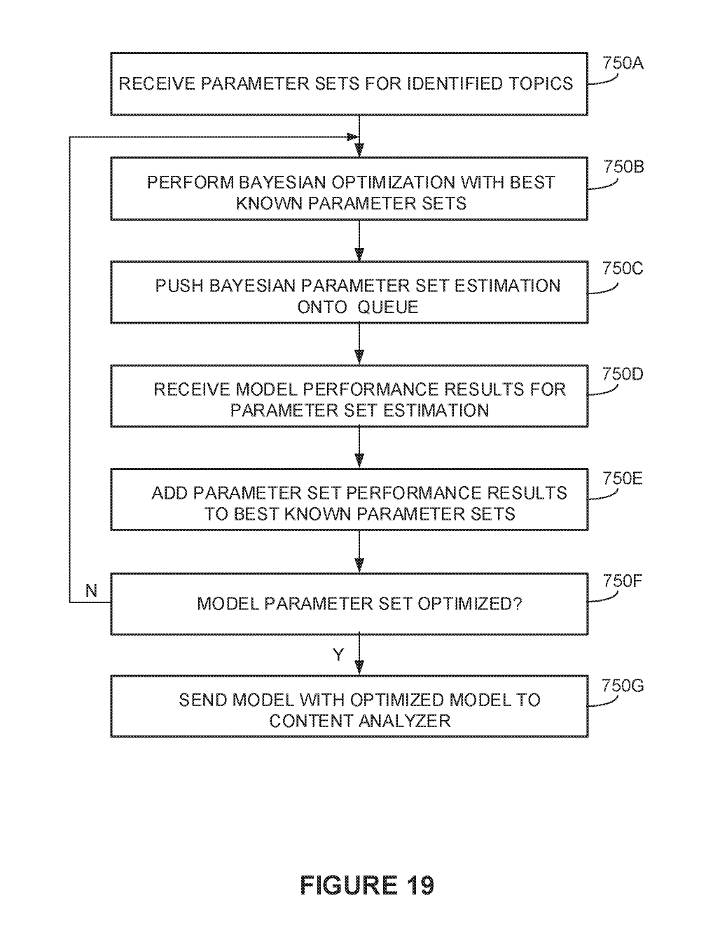

FIG. 19 shows an example process performed by the master node in the model optimizer. In operation 750A, the master node may receive and/or generate parameter sets for a set of identified topics. As explained above, the initial parameter sets may be from a similar topic list or may be a predetermined set of model parameters.

In operation 750B, the main node may perform a Bayesian optimization with the known parameter sets, calculating a next-best parameter set. In operation 750C, the next-best parameter set estimation is pushed onto the parameter set queue. The model training nodes then pulls the oldest estimated parameter sets off from the bottom of the queue.

In operation 750D, the master node receives performance results for the models trained using the Bayesian parameter set estimations. In operation 750E, the master node may add the result pair to the best-known parameter sets.

In operation 750E, the master node may determine if the result pair is optimized. For example, the master node may determine the result pair converges with previous result pairs. In another example, the master node may identify the parameter set that produces the highest model performance value after some predetermined time period or after a predetermined number of Bayesian optimizations.

If an optimized parameter set is not determined, as defined by the optimization stopping criteria, defined above, the master node may perform another Bayesian optimization in operation 750B. When an optimized parameter set is identified in operation 750F, the master node in operation 750G sends the optimized model to the content analyzer for predicting the new set of topics in content.

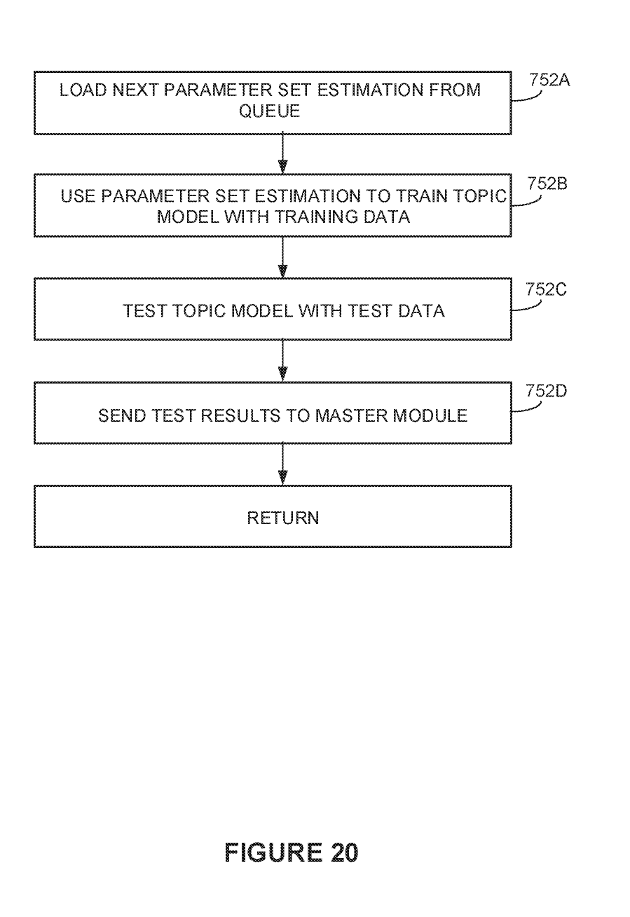

FIG. 20 shows an example process for the model training nodes. In operation 752A, the model training nodes download parameter set estimations from the master node queue. In operation 752B, the model training nodes use the parameter set estimations and training data to build/train the associated topic models. For example, the training nodes may create a set of word relationship vectors that are associated with topics in the training data.

In operation 752C, the training nodes test the built topic models with a set of test data. For example, the test data may include a list of known topics and their associated content. The training node may generate a model performance score based on the number of topics correctly identified in the test data by the trained topic model. In operation 752D, the training nodes send the parameter sets and associated test scores to the master node for generating additional parameter set estimations.

### Hardware and Software

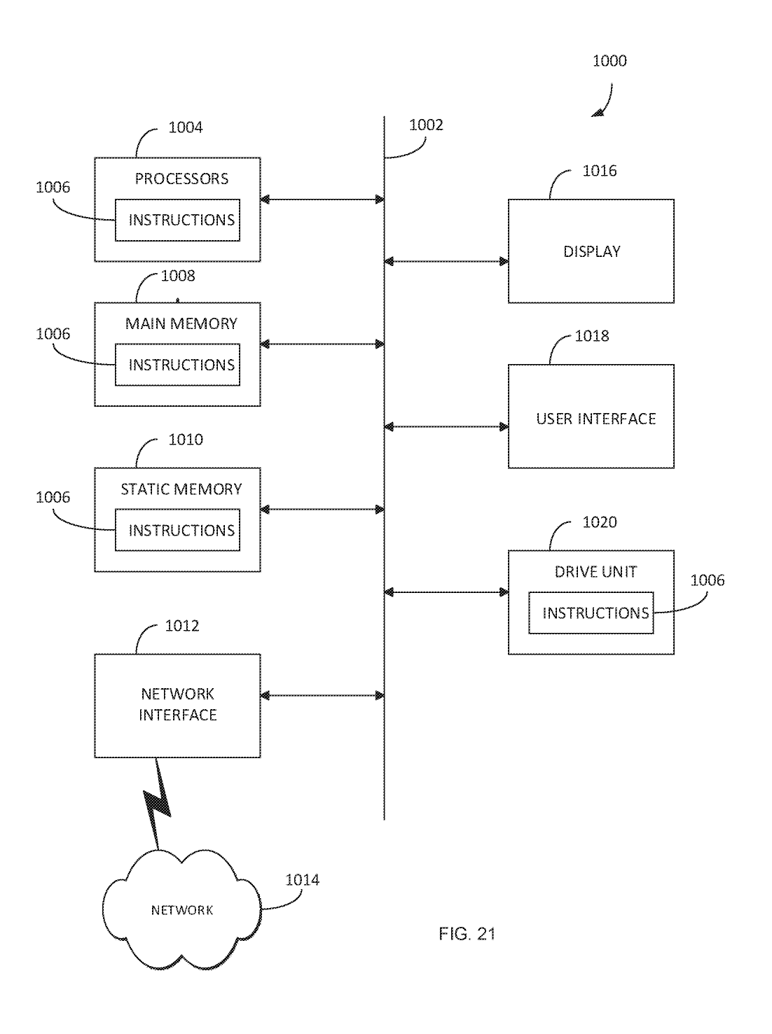

FIG. 21 shows a computing device 1000 that may be used for operating the content consumption monitor and performing any combination of processes discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT)) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A distributed model generation system for generating a topic classification (TC) model, comprising:
a master node configured to:
receive one or more known parameter sets for the TC model,
estimate parameter sets for the TC model based on the known parameter sets, and
load the estimated parameter sets into a queue; and
multiple training nodes each configured to:
download different ones of the estimated parameter sets from the queue,
train associated TC models using the downloaded estimated parameter sets,
generate model performance values for the trained TC models, the model performance values associated with the estimated parameter sets used for training the TC models, and
send the model performance values to the master node,
wherein the master node is further configured to use the model performance values and the associated estimated parameter sets to estimate additional parameter sets.

2. The distributed model generation system of claim 1, wherein the master node is further configured to use a Bayesian optimization to estimate the parameter sets.

3. The distributed model generation system of claim 1, wherein the master node is further configured to repeatedly estimate new parameter sets based on the model performance values generated by the training nodes and the associated estimated parameter sets, and load the new estimated parameter sets into the queue until at least one of the estimated parameter sets produces a target model performance value.

4. The distributed model generation system of claim 3, wherein the target model performance value converges with other model performance values or reaches a threshold value.

5. The distributed model generation system of claim 1, wherein the training nodes are further configured to automatically download additional estimated parameter sets from the queue after generating the model performance values for the trained TC models.

6. The distributed model generation system of claim 1, wherein:
the queue operates as a first in-first out queue;
the master node places the estimated parameter sets in the queue; and
the estimated parameter sets move through the queue and are taken from the queue by the training nodes.

7. The distributed model generation system of claim 1, wherein the master node is further configured to send an identified one of the TC models producing a highest one of the model performance values to a content analyzer for estimating topics in content.

8. The distributed model generation system of claim 7, wherein the content analyzer operates in a content consumption monitor and is configured to:
identify events from a domain;
identify a number of the events;
identify content associated with the events;
identify a topic;
use the identified model to identify a relevancy of the content to the topic; and
generate a consumption score for the domain and topic based on the number of events and the relevancy of the content to the topic.

9. The distributed model generation system of claim 1, wherein the training nodes operate in parallel and each includes a same instance of:
model library dependencies;
topic training data; and
topic testing data.

10. A model training system, comprising:
a processing system; and
a memory device coupled to the processing system and including instructions stored thereon that, in response to execution by the processing system, are operable to:
estimate parameter sets for a topic classification (TC) model;
distribute the estimated parameter sets to multiple different training nodes for separately training associated TC models;
receiving model performance values for the trained TC models back from the training nodes, the model performance values each associated with one of the estimated parameter sets; and
use the model performance values and the associated estimated parameter sets to generate additional estimated parameter sets for distributing to the training nodes

11. The model training system of claim 10, wherein the instructions are further operable to use a Bayesian optimization to estimate the parameter sets.

12. The model training system of claim 10, wherein the instructions are further operable to load the estimated parameter sets into a queue for distribution to the training nodes.

13. The model training system of claim 12, wherein the training nodes are configured to automatically download another one of the estimated parameter sets from the queue after generating the model performance values for a previously downloaded one of the estimated parameter sets.

14. The model training system of claim 12, wherein the estimated parameter sets are placed in the queue until downloaded by the training nodes.

15. The model training system of claim 10, wherein the instructions are further operable to repeatedly generate new estimated parameter sets until the model performance values converge or at least one of the model performance values reaches a threshold value.

16. The model training system of claim 10, wherein the instructions are further operable to send one of the trained TC models producing a highest one of the performance values to a content analyzer for estimating topics in content.

17. A model training system, comprising:
a processing system; and
a memory device coupled to the processing system and including instructions stored thereon that, in response to execution by the processing system, are operable to:
access a queue to download an estimated parameter set for a topic classification (TC) model;
train the TC model using the estimated parameter set;
calculate a model performance value for the trained TC model, the performance value associated with the estimated parameter set used for training the TC model; and
send the model performance value and the estimated parameter set to a master node for generating an additional estimated parameter set for training the TC models.

18. The model training system of claim 17, wherein the master node uses a Bayesian optimization to estimate the parameter set.

19. The model training system of claim 17, wherein the instructions are further operable to automatically download an additional estimated parameter set from the queue for retraining the TC model after generating the model performance value for the previously trained TC model.

20. The model training system of claim 17, wherein the instructions are further operable to load multiple instances of training nodes on a server system, each of the training nodes configured to:
download different estimated parameter sets from the queue;
train associated TC models in parallel using the different downloaded parameter sets;
calculate in parallel model performance values for the associated trained TC models; and
send the model performance values to the master node for estimating new parameter sets.
